(19) United States
(12) Patent Application Publication
(10) Pub. No.: US 2015/0127275 A1
(43) Pub. Date: May 7, 2015

(54) FLOW METER SYSTEM

(71) Applicant: HydroVision Asia Pte Ltd, Singapore (SG)

(72) Inventors: Thomas Hies, Singapore (SG); Juergen Skripalle, Irsee (DE)

(21) Appl. No.: 14/398,731

(22) PCT Filed: May 6, 2013
(86) PCT No.: PCT/IB2013/053606

§ 371 Date: Nov. 4, 2014

(30) Foreign Application Priority Data
May 4, 2012 (SG) PCT/SG2012/000159

(51) Int. Cl. G01F 1/66

(52) U.S. Cl. CPC G01F 1/66
USPC 702/48

(57) ABSTRACT

The application provides an acoustic flow meter for a fluid conduit. The flow meter has one or more acoustic transmitter and receiver pairs, a holder, an interface unit, and a computer module. The acoustic transmitter and receiver pair measures a flow speed value of a fluid in the fluid conduit. The holder fixes the acoustic transmitter and receiver pair to the fluid conduit. The interface unit receives a type data, a position data, and an orientation data of a fluid disturbance element, and a position data and an orientation data of the acoustic transmitter and receiver pair. The computer module has a memory unit, a processor, an output device. The memory unit stores a relationship data set. The processor computes a flow rate of the fluid by using the relationship data set type. The output device outputs the flow rate.

The present application relates to a system and to a method for determining a rate of flow of a fluid in a fully filled conduit, the fluid includes both liquids and gases.

There are currently discharge measurement techniques for completely filled pipes. However, instead of measuring the velocity distribution, these methods assume a velocity distribution, which corresponds to a fully developed velocity profile. Unfortunately, the assumed fully developed velocity profile only exists in regions of the pipe where changes of the velocity distribution in flow direction are very small and not along lengths of entire pipes. Many existing techniques for discharge measurement require extended regions of straight pipes, and such pipes may be unavailable in premises, which are space-constrained.

Many industrial applications deal with fluids in complex pipe systems. Such industrial applications include, for example, food production, oil/gas refineries, water power plants, waste water treatment plants and so forth. Typically it would be useful to know how much fluid is moving past a particular point in such conduits in a given time period, i.e. volumetric flow rate. To estimate this accurately, it is necessary to know the average flow velocity across the entire cross section of the conduit. However, the flow velocity varies widely across the cross section of conduit. Thus, usually it is not possible to use a single flow sensor to detect the average flow velocity. Even with multiple flow sensors, there may still be a significant error, which is known as the profile factor. Prior knowledge of the profile factor can be used to correct the velocity measurements made by flow sensors to a true spatially averaged velocity.

The velocity profile within a pipe is a function of at least two sets of forces: inertial forces and viscous/friction forces. For example, at the outlet of an elbow or similar piping component that changes the direction of the flow, the inertial forces dominate often resulting in a grossly distorted velocity profile. The viscous/friction forces then become more dominant as the distance from the elbow/disturbance increases. It is the viscous/friction forces along the pipe wall that dissipate the distortion caused by the inertial forces. If the pipe is long enough, the effects of the inertial forces are completely eliminated and a “fully developed” condition is reached where the flow profile does not change. Unfortunately, in practice it can take a length of fifty pipe diameters or more for the profile to be “fully developed”.

The shape of the profile when “fully developed” is a function of the viscosity and roughness of the pipe wall. In most applications, the viscosity is not well known and the effective roughness of the pipe wall is typically never defined. As a result, the profile factor in “fully developed flow” can vary by +/−10% depending on the fluid viscosity and wall roughness (from laminar flow regimes up to turbulent flow regimes). As such, it is evident that correctly compensating for the variation in the profile factor affects the accuracy of the flow meter.

Flow meters are also sensitive to velocity profiles where there is a large rotational component (swirl). Swirl is normally generated by two or more out of plane changes in flow direction (e.g. one elbow/tee that goes from vertical to horizontal followed by an elbow/tee that changes the direction of flow in the horizontal plane). Swirl is present to some extent in almost every application and can generate significant transverse velocity components plus it takes a long distance to dissipate. If the swirl is not centred, it can cause significant errors.

Space constraints and/or appropriate application configurations lead to complex industrial pipe flows, which contain elbows, tees and/or other disturbing and non-uniform elements. This leads to difficulties in installing flow meters at a recommended “optimum” location, which is defined by a minimum distance upstream or downstream of known disturbances like an elbow or pump where a fully developed velocity profile is present.

Therefore, in order to increase the accuracy of flow meters installed in complex pipe systems, flow meters need to be calibrated. Depending on the required accuracy, flow meter manufacturers commonly employ the following types of calibration techniques, namely:

1. Factory calibration of the flow meter after the manufacturing process conducted in test rigs, and
2. “Wet” calibration of the flow meter at the site of use.

With regard to the first type of calibration, a test rig contains a well-defined pipe system generating a fully developed velocity profile of the liquid or gas with an axial symmetric shape and without any swirl (by using an integrated flow straightener). Typically, for reference purposes, a master flow meter, a dynamic weighing tank or a mono or bidirectional pipe prover is installed, which will deliver the correct values for the different volumes/masses flowing through the test rig. In parallel, the test flow meter is installed and the measured flow values are being recorded. Based on the deviations between the master flow meter and the test flow meter, correction operations are being calculated. These correction operations will be used to adjust the test flow meter either physically (e.g. adjusting calibration screws) or electronically (e.g. storage of the correction operation) in order to calibrate the output of the meter to give the specified output signal for a given flow condition within a specified tolerance.

Since the calibrated and/or certified accuracy does not often relate to actual site conditions, the measured flow rates might not relate well to the actual flow rate and the accuracy might be compromised depending on the installation conditions and deviations from the manufacturers' recommendation of the ‘optimum’ installation condition.

With regard to the second type of calibration, for instance, an on-site meter prover calibration skid is mounted at the installation location taking the specific site condition into account. Alternatively, in-situ point measurements of the actual velocity profile within the cross-section of the pipe can also be carried out. The results of those measurements will be compared with the results of the installed flow meter and correction operations are calculated. These location dependent correction operations will be stored electronically or physical adjustments of the flow meter apparatus will be applied to estimate the average flow rate across the conduit.

In view of the preceding paragraphs, it should be appreciated that re-calibration either at a test rig is expensive as the apparatus needs to be dismantled and sent to a test rig location which results in downtime or is a mandatory and expensive on-site wet calibration.

US 2010/0107776 A1 provides a flow meter that comprises a transmitter for a magnetic flow meter. The transmitter comprises a current source, memory and a signal processor. The current source energizes the flow meter, such that the flow meter generates an induced electromotive force in response to a process flow. The memory stores a flow configuration that describes a flow pipe disturbance in the process flow. The signal processor determines the flow rate as a function of the induced electromagnetic force, and as a further function of the flow configuration.

The Electromagnetic flow meter does use two electrodes to generate an electromagnet field, however these electrodes do neither send and receive signals like in the acoustic measurements nor do they span/represent a measurement path. In particular these paths require an orientation information related to the flow profile and therefore related to the disturbance.

JP 6041860 B provides a method to measure a flow rate in a turbulence area of a gas pipe having a bent part. A turbulence error coefficient in an inner-pipe section measured by an analogous model pipe obtained by scaling down an actual bent part is corrected by a flow rate value measured in the turbulence area of the actual bent part.

The application provides a system and a method for determining a rate of fluid flow (includes both liquids and gases) in a fully filled conduit.

In a first aspect, there is provided a system for measuring fluid flow. The system comprises a user interface configured to determine conduit configuration parameters for a selected conduit installation site; an information repository configured to store a plurality of correction operations associated with at least one of predetermined conduit configuration parameters and a flow rate at the selected installation site; a flow sensor configured to measure the flow rate at the selected installation site; and a controller configured to apply the selected correction operation from the information repository to the flow rate from the flow sensor to estimate the average flow rate in the conduit at the selected installation site.

It is preferable that the conduit configuration parameters are selected from, for example, geometrical run of the conduit, disturbance element, conduit diameter, distance from disturbance and any combination thereof. The conduit is preferably a closed pressurized pipe.

Preferably, determining conduit configuration parameters includes either a user entering the parameters or automatic measurement of the parameters.

It is also preferable that the flow sensor is part of a flow meter and is selected from, for example, mechanical flow meters, optical flow meters, ultrasonic flow meters, differential pressure meters, positive displacement meters, inferential meters, oscillatory flow meters, vortex flow meters, Coriolis mass flow meters, thermal mass flow meters, electromagnetic flow meters and the like.

The user interface is of a form such as, for example, graphical, electronic, mechanical, voice-operated, mechatronic and any combination thereof.

Furthermore, the graphical user interface may include at least one of: an alphanumeric menu, a pull down menu, a list box menu, a combo box menu, a check box menu, a graphical selection menu, and a direct data entry field.

It is preferable that the correction operation is selected from, for example, values, matrixes, functions, algorithms, real-time simulations, physical models, surrogate models and any combination thereof.

The user interface may be configured to be located on-site with the flow sensor, configured to be mobile and connectable to the system during selection of the correction operation, or configured to be located remote from the flow sensor.

In a second aspect, there is provided a method for measuring fluid flow. The method comprises determining conduit configuration parameters for a selected conduit installation site; measuring a flow rate in a conduit at the installation site; determining a correction operation from a lookup table based on at least one of the conduit configuration parameters and the flow rate; and estimating the average flow rate in the conduit at the installation site by applying the correction operation to the measured the flow rate.

It is preferable that the conduit configuration parameters are selected from, for example, geometrical run of the conduit, disturbance element, conduit diameter, distance from disturbance and any combination thereof.

Preferably, the conduit configuration parameters are determined using a user interface of a form such as, for example, graphical, electronic, mechanical, voice-operated, mechatronic and any combination thereof. Furthermore, the graphical user interface may include at least one of: an alphanumeric menu, a pull down menu, a list box menu, a combo box menu, a check box menu, a graphical selection menu, and a direct data entry field. Determining conduit configuration parameters may inelude either a user entering the parameters or automatic measurement of the parameters.

It is preferable that the correction operation is selected from, for example, values, matrixes, functions, algorithms, real-time simulations, physical models, surrogate models and any combination thereof.

In a final aspect, there is provided a user interface for a system for measuring fluid flow. The interface comprises a memory configured to store a lookup table of correction operations for predetermined conduit configurations, an input device configured to receive a user selection of a conduit configuration at a conduit installation site; and a communication module configured to communicate the corresponding correction operation for the selected conduit configuration at the conduit installation site to a flow sensor.

The input device may be selected from a form such as, for example, graphical, electronic, mechanical, voice-operated, mechatronic, and any combination thereof. The graphical input device preferably includes at least one of, for example, an alphanumeric menu, a pull down menu, a list box menu, a combo box menu, a check box menu, a graphical selection menu, a direct data entry field and the like. The user interface may be located either on-site or remote from the conduit installation site.

The application provides an acoustic flow meter measuring a flow rate of a liquid in a liquid conduit. The flow meter is often within 5 conduit diameters from a disturbance element, where the disturbance from the disturbance element can be observed at the flow meter.

The application relates to measurements of liquids, which are different from gases or mixtures of gases and liquids that are seen as compressible mediums by the persons skilled in the art.

The flow meter includes one or more acoustic transmitter and receiver pairs, a holder, an interface unit, and a computer module.

The acoustic transmitter and receiver pair measures a flow speed value of a liquid in the liquid conduit.

The holder fixes the acoustic transmitter and receiver pair to the liquid conduit. The fixing clamps the acoustic transmitter and receiver pair to the liquid conduit, wherein the acoustic transmitter and receiver pair are not wetted.

The liquid conduit often has openings for allowing acoustic signals of the acoustic transmitter and receiver pair to reach the liquid. A transmitter of the pair transmits an acoustic signal while a receiver of the pair receives and measures the signal. A flow rate of the liquid affects the time of receiving the signal. Thus, the measuring of the signal can serve to determine the flow rate of the liquid.

The interface unit receives a type data, a relative position data, and a relative orientation data of a liquid disturbance element. The relative position data is defined with respect to the flow meter. The relative orientation data is also defined with respect to the flow meter. The position data can refer to a set of data for defining the position of the liquid disturbance element. Likewise, the orientation data can refer to a set of data for defining the orientation of the liquid disturbance element.

A user may input these data to the interface unit. The liquid disturbance element is often placed upstream from the liquid conduit. In other words, the liquid flows from the disturbance element to the liquid conduit. An example of the disturbance element is an elbow conduit. The type, the position, and the orientation of the disturbance element act to interfere with the flow of the liquid and may introduce swirls or other interference to the liquid.

The interface unit is used for receiving, by a user input, a relative position data and a relative orientation data of the liquid disturbance element.

The computer includes a memory unit, a processor, and an output device

The memory unit stores the type data, the position data, and the orientation data of the liquid disturbance element and a plurality of pre-determined types, and pre-determined orientations of a liquid disturbance element.

The processor computes a flow rate of the liquid according to the type data, the position data, and the orientation data of the liquid disturbance element, and the flow speed value from the acoustic transmitter and receiver pair.

The output device outputs the flow rate for showing the flow rate to the user.

The orientation of the disturbance element relative to the orientation of the flow meter would affect or determine the flow velocity profile of the fluid at the flow meter.

The affected flow velocity profile, in turn, would affect the readings of the acoustic transmitter and receiver pair. The acoustic transmitter and receiver pair have an acoustic measurement path with a pre-determined orientation and position. The measurement path is also placed in an acoustic plane with a pre-determined orientation and position.

Changes in the flow velocity profile would lead to a change in the readings of the acoustic transmitter and receiver pair. In other words, the change of flow velocity profile would contribute to errors in the readings of the acoustic transmitter and receiver pair.

By considering the relative orientation of the disturbance element, the effects of the orientation of the disturbance element can be estimated and can be compensated. In essence, the errors due to orientation of the disturbance element can be essentially eliminated.

This is different from prior art, such as US 2010/010776A1, which is silent regarding orientation of the disturbance element.

The flow meter can include at least two acoustic transmitter and receiver pairs, wherein each acoustic transmitter and receiver pair measures a flow speed value of the liquid in the liquid conduit at a different level within the liquid conduit. The flow meter can have several measurement planes, each measurement plane is placed at a different level.

The flow meter can also have a means for individually activating the acoustic transmitter and receiver pairs at different times such that acoustic signals of the transmitter and receiver pairs does not interfering with each other. When one acoustic transmitter and receiver pair is activated, the other acoustic transmitter and receiver pairs are inactive, thereby eliminated interference from other transmitter and receiver pairs for improving accuracy.

The output device can be configured to display the pre-determined types of a liquid disturbance element for a user selection of a specific type data through the interface unit. In effect, this allows the user to select the required type of disturbance element. The output device can also display other data for the user selection.

The memory unit can also stores a plurality of corresponding pre-determined positions and corresponding pre-determined orientations of the acoustic transmitter and receiver pair, wherein the processor also computes the flow rate according to a position data and an orientation data of the acoustic transmitter and receiver pair.

The interface unit can also receive the position data and the orientation data of the acoustic transmitter and receiver pair. These data can be used to define the relative position and the relative orientation of the disturbance element.

The memory unit can also stores a plurality of pre-determined flow rates, a plurality of corresponding pre-determined positions of the liquid disturbance element, and a plurality of corresponding pre-determined flow speed values of the acoustic transmitter and receiver pair.

The application also provides a method of operating an acoustic flow meter for measuring a liquid flow. The acoustic flow meter is attached to liquid conduit.

The method includes a step of providing a relational data set, which has a plurality of pre-determined flow rates.

The data set also includes a plurality of corresponding pre-determined types and corresponding pre-determined relative orientations of the liquid disturbance elements. The relative orientations of the liquid disturbance elements are defined with reference to a position and an orientation of the flow meter.

The data set often includes corresponding relative positions of the_liquid disturbance elements. The relative positions of the liquid disturbance elements are defined with reference to a position and an orientation of the flow meter.

The data set also includes a plurality of corresponding pre-determined flow speed values of the acoustic transmitter and receiver pair.

After this, the flow meter receives a type data, a position data, and an orientation data of a liquid disturbance element for a user. The disturbance element is placed upstream from the flow meter and the disturbance element affects the flow profile of the liquid that is flowing from the disturbance element to the flow meter.

After this, the flow receives a flow speed value of a liquid from the acoustic transmitter and receiver pair.

The flow meter then determines a flow rate of the liquid by using the relational data set according to the type data, the position data, and the orientation data of the liquid disturbance element, the position data and the orientation data of the acoustic transmitter and receiver pair, and the flow speed value from the acoustic transmitter and receiver pair.

The flow meter later outputs the flow rate for displaying to the user of the flow meter.

The method often includes a step of the flow meter receiving a position data and an orientation data of an acoustic transmitter and receiver pair.

For calibrating the flow meter, the method often includes a step of simulating a flow profile of the liquid according to a flow rate, and to the type data, the position data, and the orientation data of the liquid disturbance element.

This step serves to determine the flow profile of the liquid at the flow meter. This simulation is often accurately using techniques that require a large computing resource, which the flow meter cannot provide. This step is performed before using the flow meter to measure the flow rate.

After this, the flow profile is stored in the relational data set with the corresponding flow rate and with the corresponding type data, the corresponding position data, and the corresponding orientation data of the liquid disturbance element. This storing allows the later retrieving of the flow profile.

The method often also includes a step of simulating a flow speed value of the acoustic transmitter and receiver pair according to the above flow profile and to and the position data and the orientation data of the acoustic transmitter and receiver pair. Put differently, this step simulates the measuring of the acoustic transmitter and receiver pair based on the flow profile of the liquid and on the position and orientation of the acoustic transmitter and receiver pair.

The flow speed value of the acoustic transmitter and receiver pair is later stored in the relational data set with the corresponding flow profile and with the corresponding position data and the corresponding orientation data of the acoustic transmitter and receiver pair. This storing allows the later retrieving of the flow speed value.

For calibrating the flow meter, the method can include a step of simulating a first flow rate using an integration method according to a flow speed value of the liquid of the acoustic transmitter and receiver pair. The OWICS method does not requires much computing resources and can be simulated rather quickly.

The integration method can include an “Optimal Weighted Integrated For Circular Sections” (OWICS) method, which is disclosed in Tresch T., Gruber P., Luscher B., Staubli T., Presentation of Optimized Integration Methods and Weighting Corrections for the Acoustic Discharge Measurement, IGHEM 2008, Milano.

The first flow rate with the corresponding flow speed value is later stored in the relational data set.

The method often includes a step of simulating a second flow rate using a finite element method according to the type data, the position data, and the orientation data of the liquid disturbance element.

The finite element method can include a Computational Fluid Dynamics (CFD) method although other flow simulating methods, which are discrete and continuous, are also possible. The CFD method generally produces more results while requiring a large computing resource.

A compensation factor for the first flow rate with respect to the second flow rate is then determined. Due to the different methods of deriving these flow rates, the second flow rate is more accurate while requiring more computing resources while the first flow rate is less accurate while requiring less computing resources. The compensation factor serves to derive the second flow rate from the first flow rate.

After this, the compensation factor with the corresponding first flow rate and with the corresponding type data, the corresponding position data, and the corresponding orientation data of the liquid disturbance element is stored in the relational data set.

To operate the flow meter, the determination of the flow rate often includes retrieving an interim flow rate from the relational data set according to the flow speed value of the liquid of the acoustic transmitter and receiver pair.

A compensation factor from the relational data set is then retrieved according to the immediate flow rate and to type data, the position data, and the orientation data of the liquid disturbance element

After this, a final flow rate is derived according the interim flow rate and the compensation factor.

In order that the present application may be fully understood and be readily put into practical effect, there shall now be described by way of non-limitative example, with reference to the accompanying illustrative figures, in which:

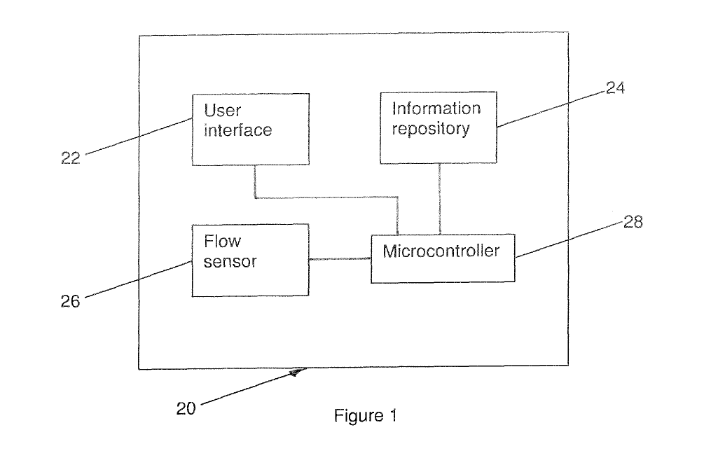

FIG. 1 illustrates a block diagram of a system according to a first embodiment,

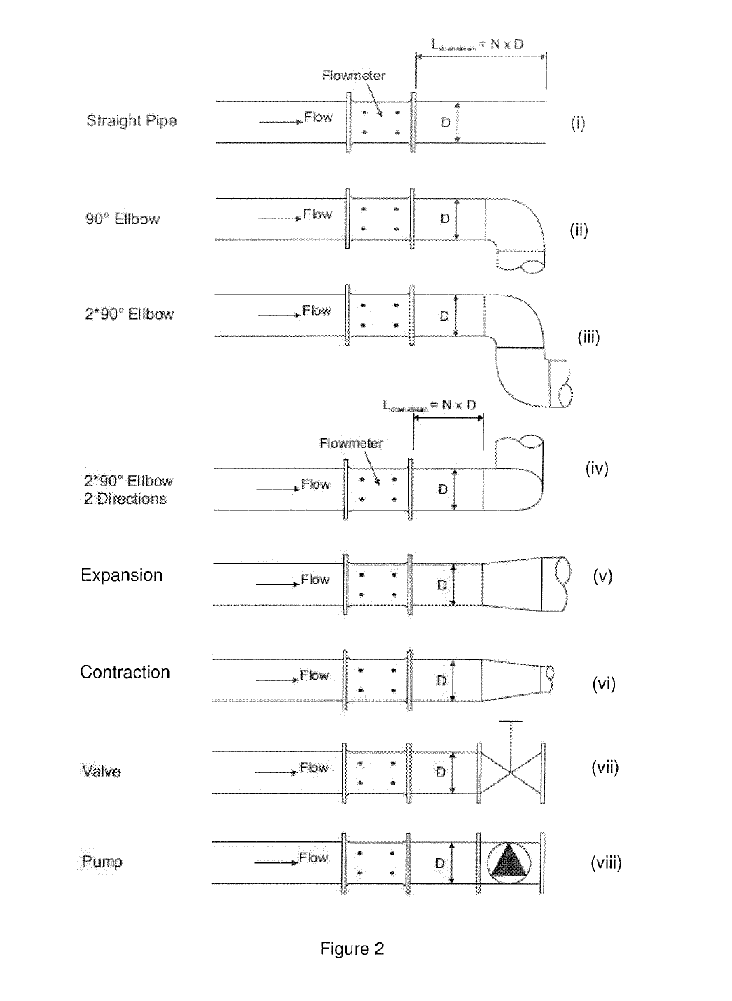

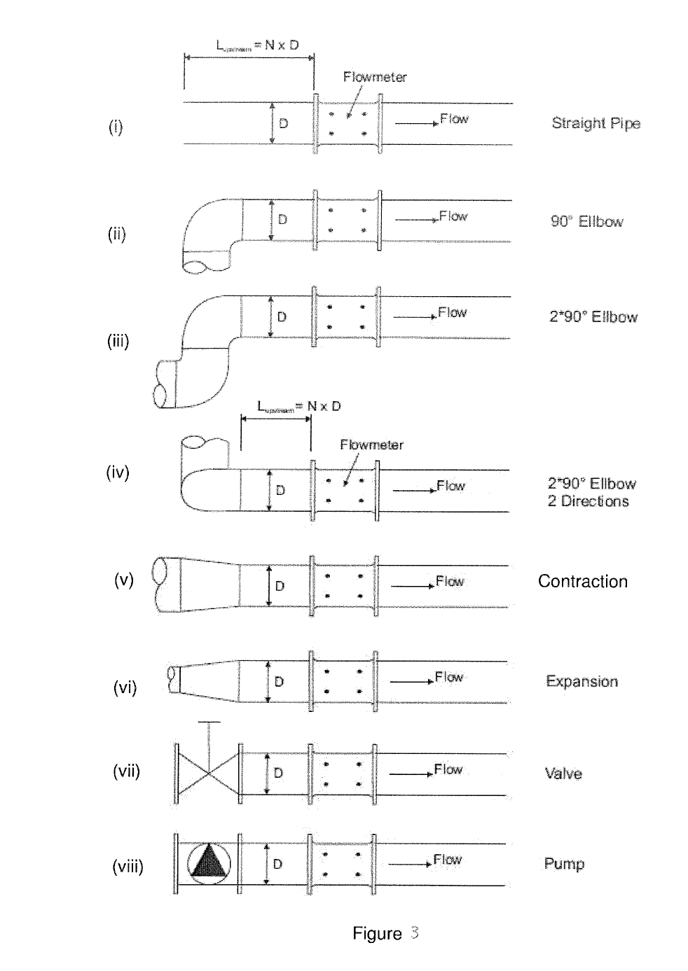

FIGS. 2 and 3

illustrate schematic views of different installation locations for the system in FIG. 1,

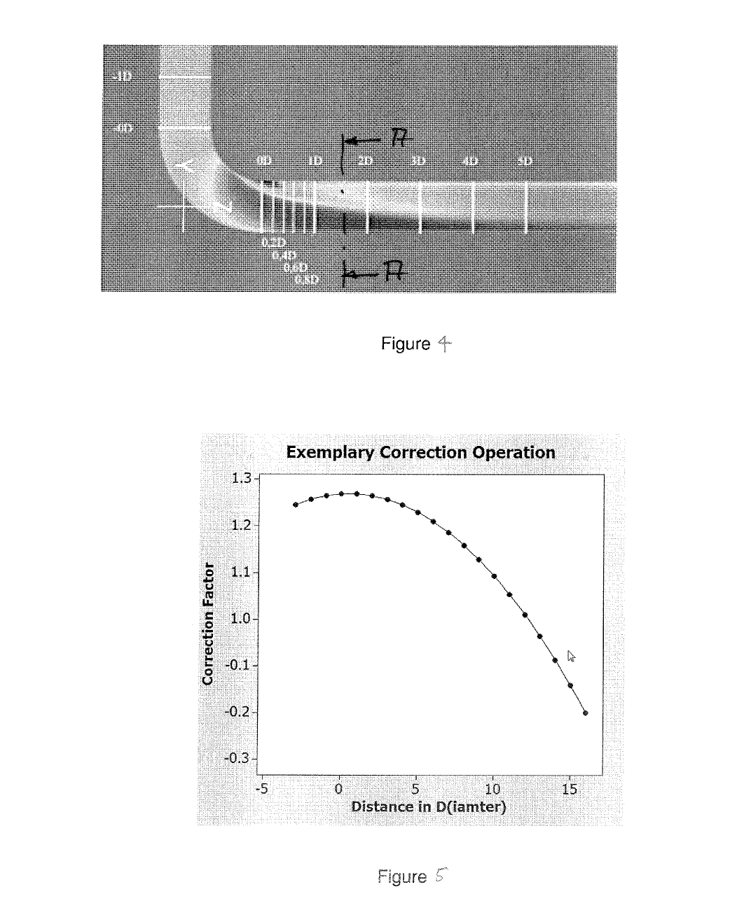

FIG. 4 illustrates a graph of flow velocities in a 90-degree elbow conduit,

FIG. 5 illustrates a graph of exemplary correction operations,

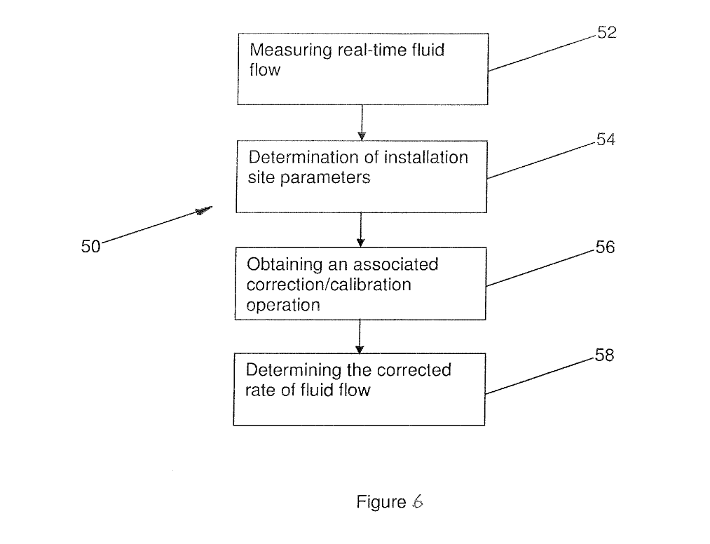

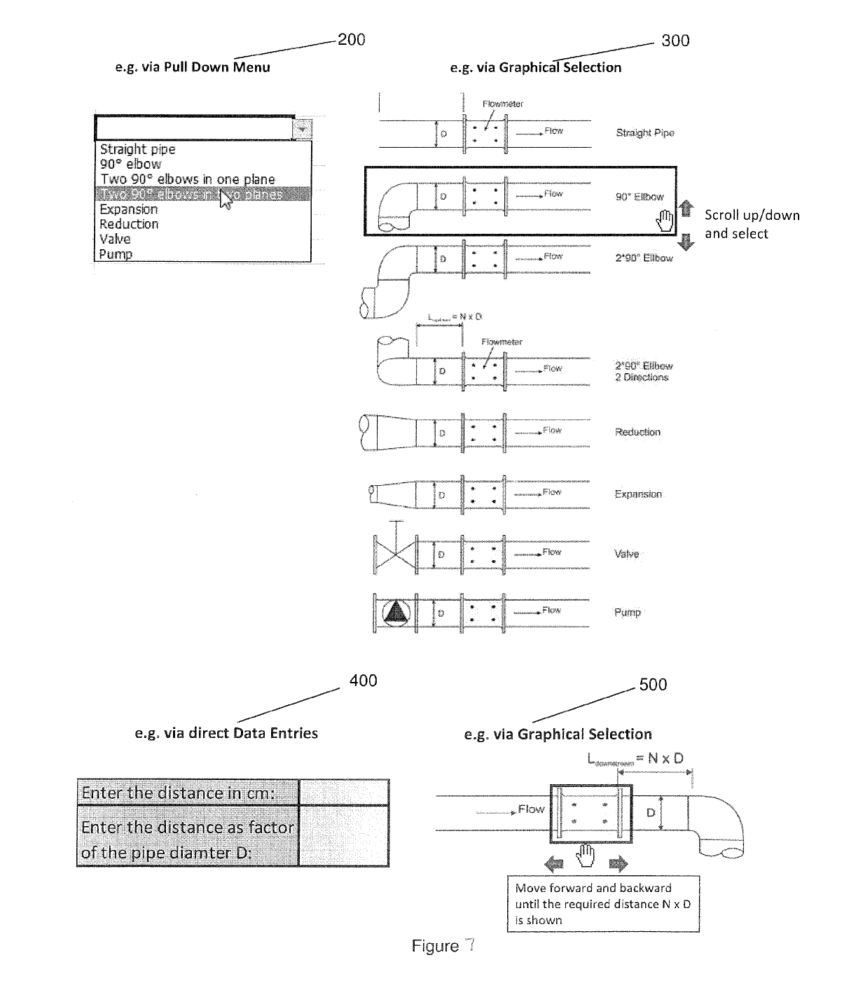

FIG. 6 illustrates a flow chart of a method according to a second embodiment,

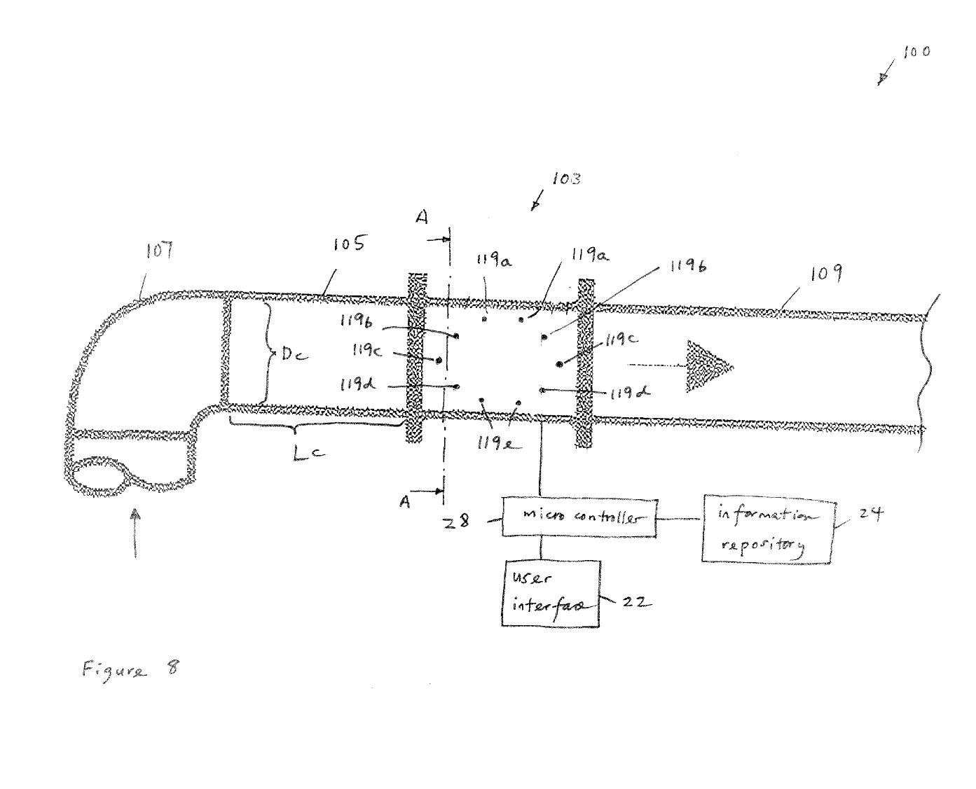

FIG. 7 illustrates examples of a user interface of the system of FIG. 1,

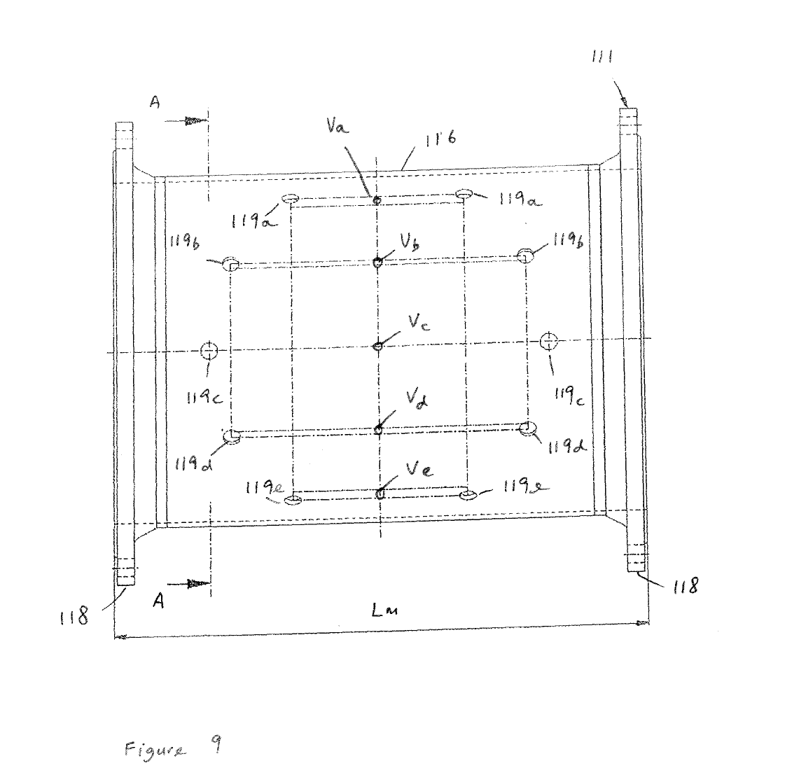

FIG. 8 illustrates a front view of an acoustic flow meter being connected to conduits according to one embodiment of the system of FIG. 1,

FIG. 9 illustrates a front view of a spool piece of the acoustic flow meter of FIG. 8,

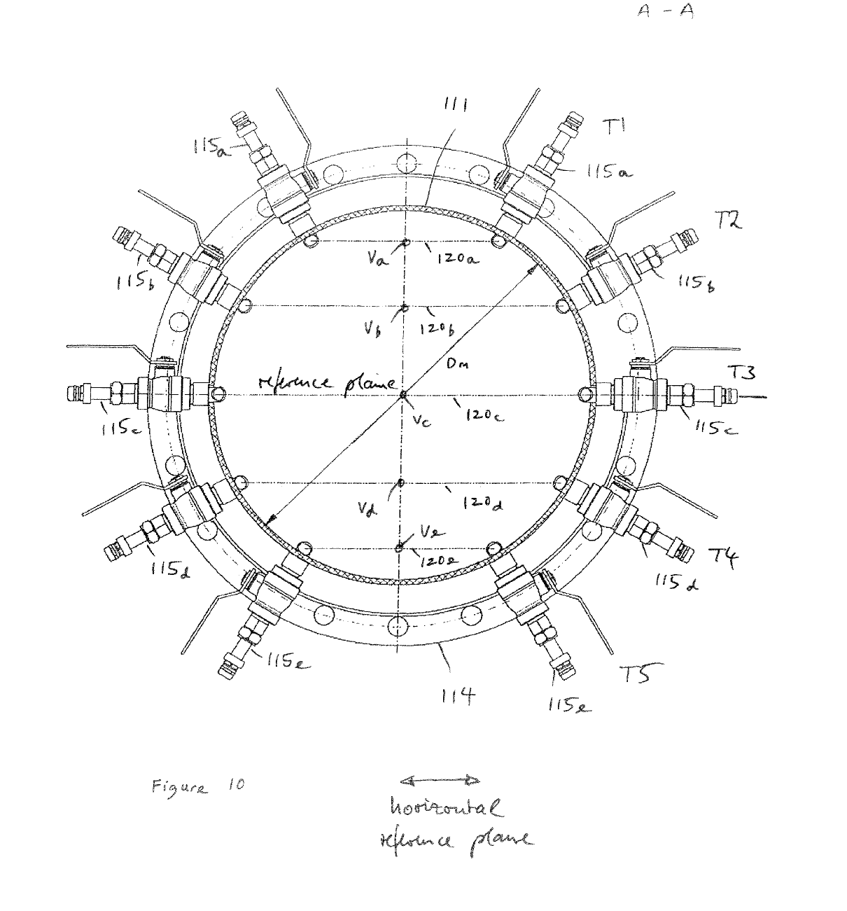

FIG. 10 illustrates a cross-sectional side view of the acoustic flow meter of FIG. 8, taken along plane A-A,

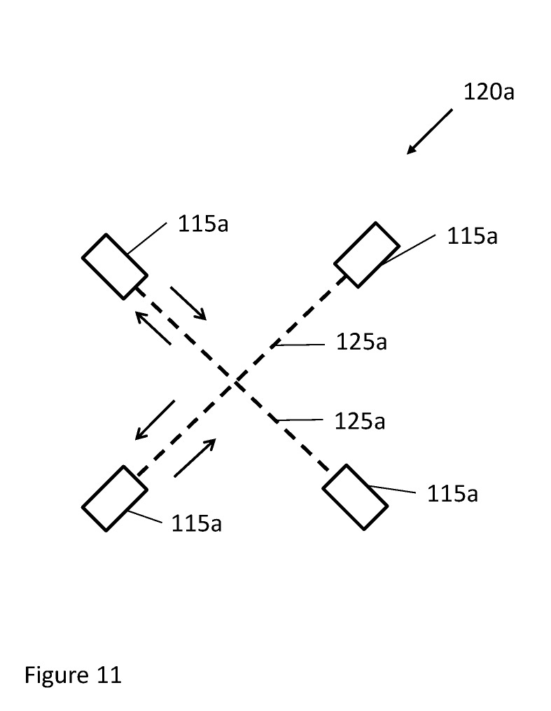

FIG. 11 illustrates a top view of an acoustic plane of the acoustic flow meter of FIG. 8,

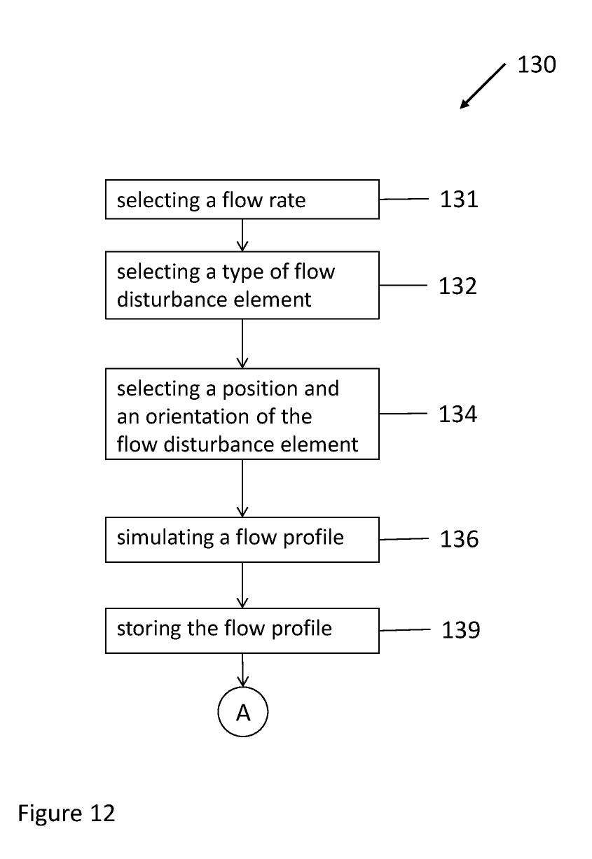

FIG. 12 illustrates a flow chart of a method for generating flow profile for the acoustic flow meter of FIG. 8,

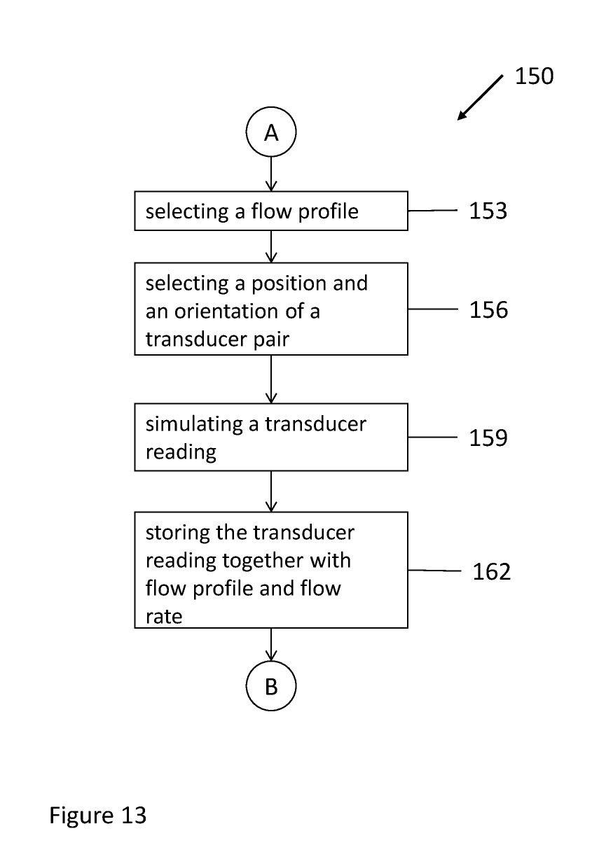

FIG. 13 illustrates a flow chart of a method of generating transducer readings for the acoustic flow meter of FIG. 8,

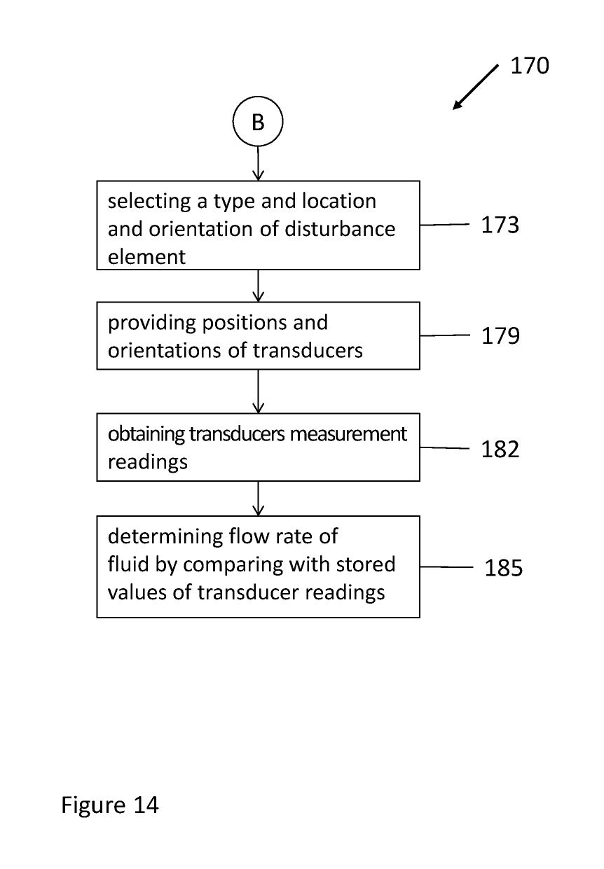

FIG. 14 illustrates a flow chart of a method of operating the acoustic flow meter of FIG. 8,

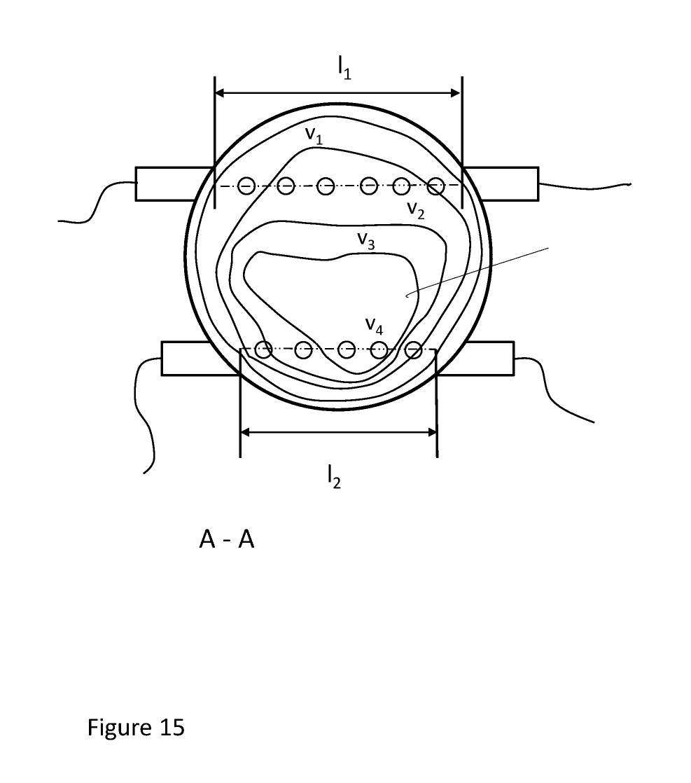

FIG. 15 illustrates flow profiles at the flow meter of FIG. 10, taken along plane A-A,

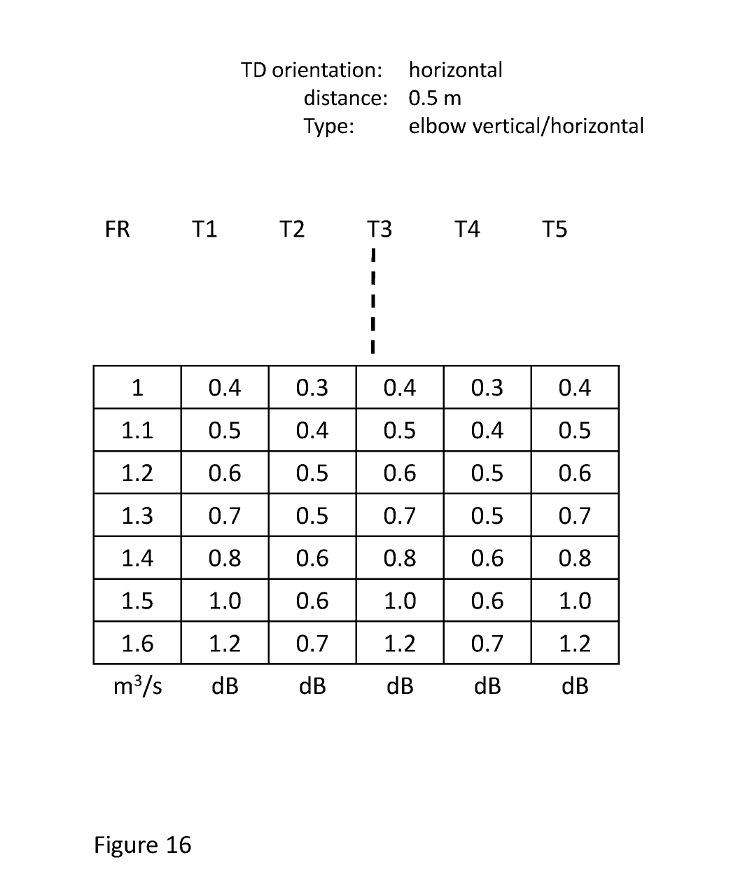

FIG. 16 illustrates a data set of flow rates and transducer readings of transducers of the flow meter of FIG. 10,

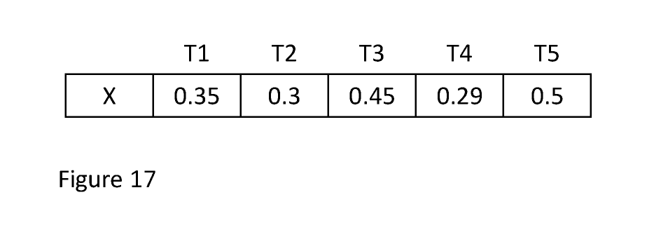

FIG. 17 illustrates transducers readings of the flow meter of FIG. 10,

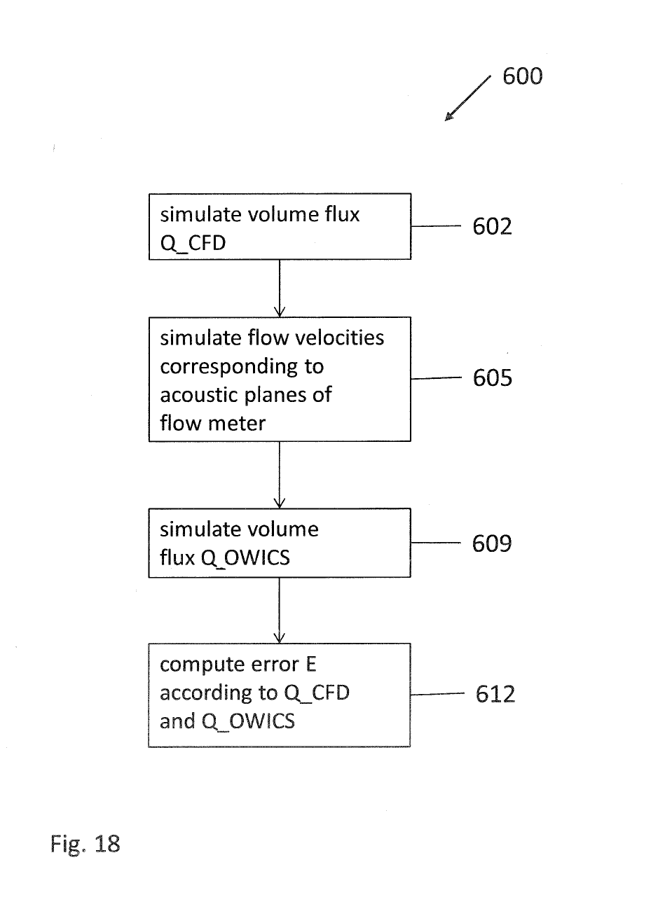

FIG. 18 illustrates a method of using the flow meter of FIG. 8,

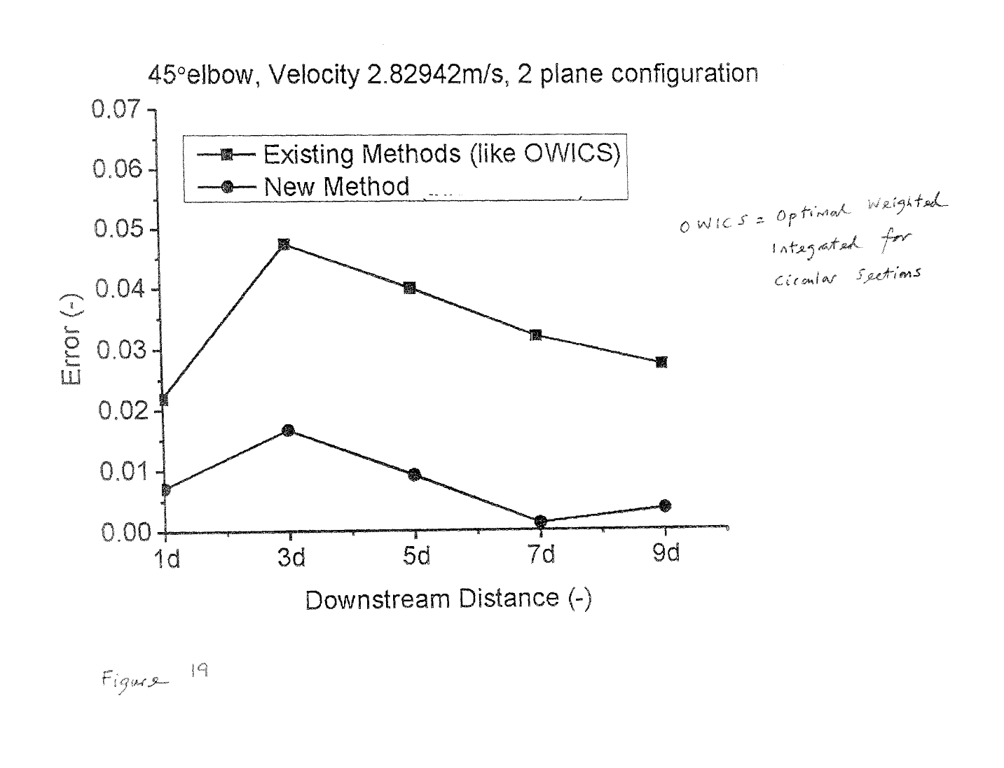

FIG. 19 illustrates flow rate measurement error graphs for a first flow system,

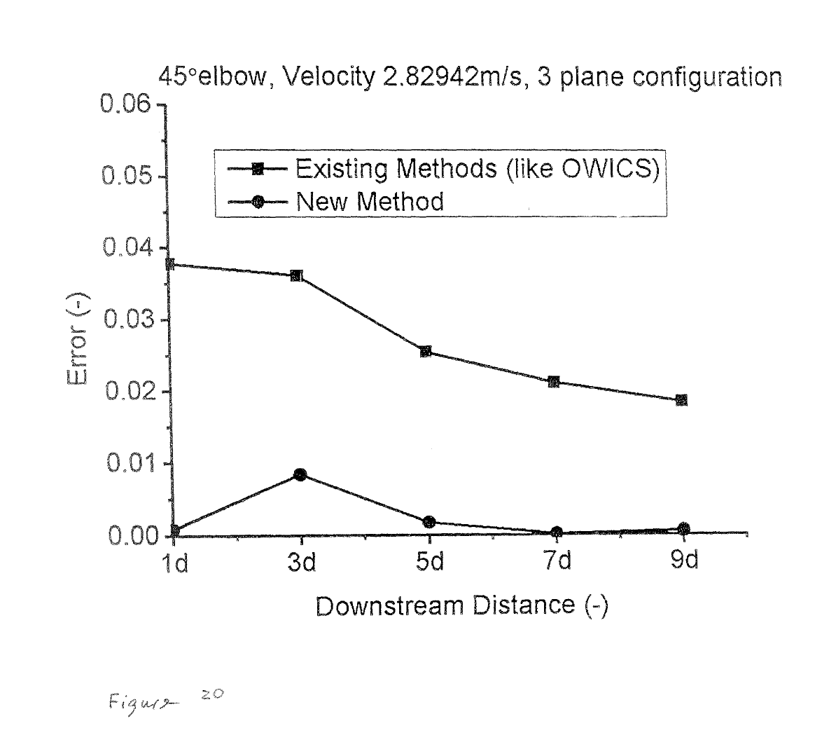

FIG. 20 illustrates flow rate measurement error graphs for a second flow system,

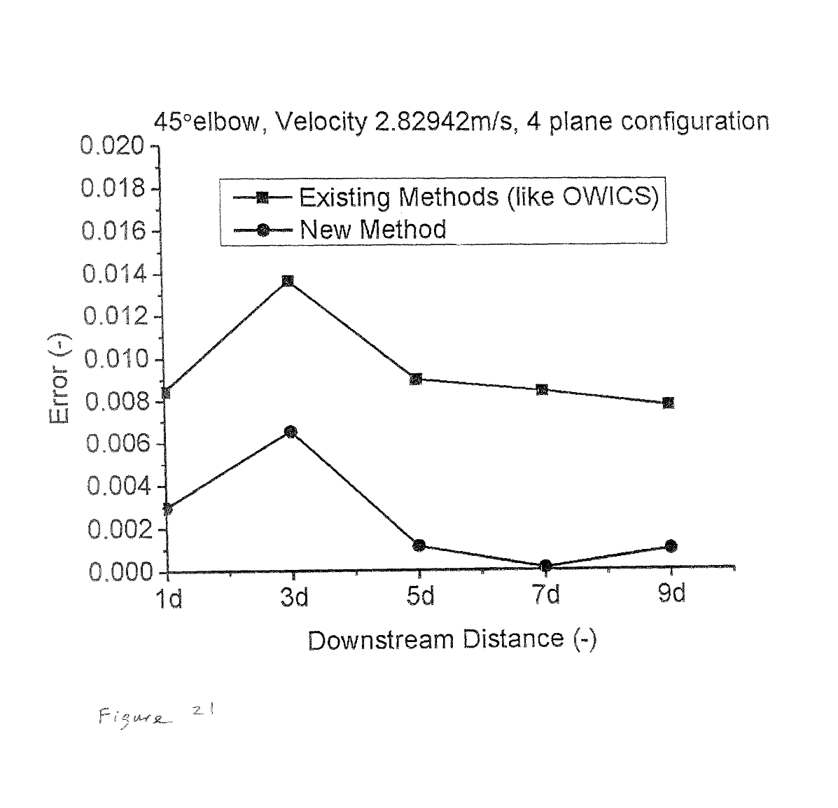

FIG. 21 illustrates flow rate measurement error graphs for a third flow system,

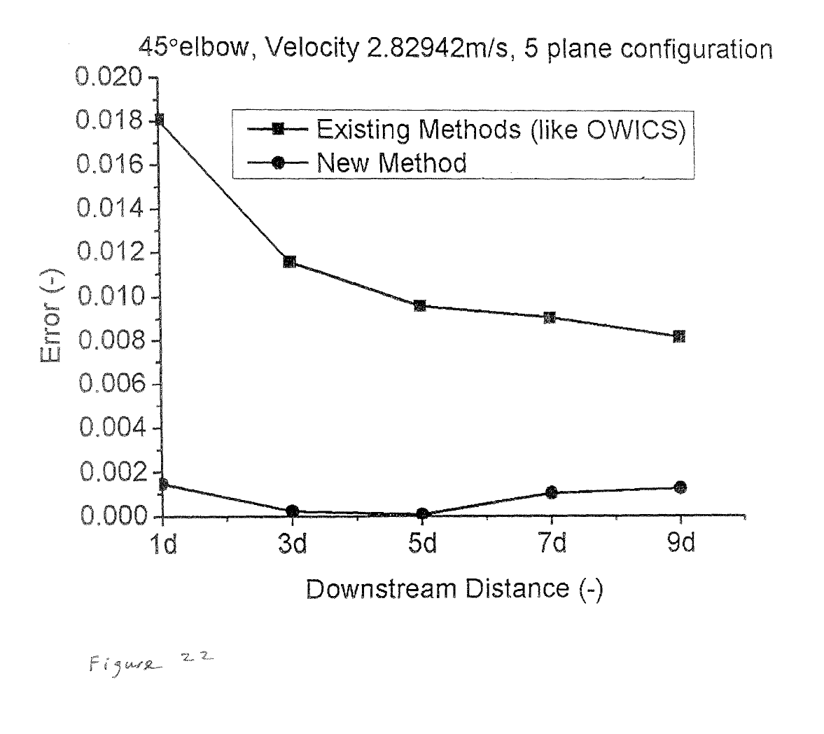

FIG. 22 illustrates flow rate measurement error graphs for a fourth flow system,

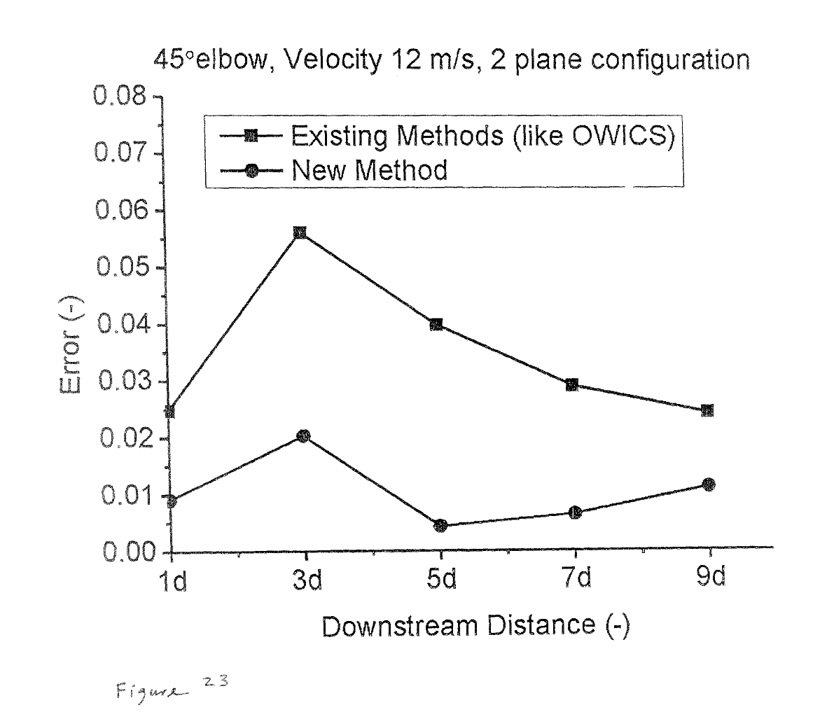

FIG. 23 illustrates flow rate measurement error graphs for a fifth flow system,

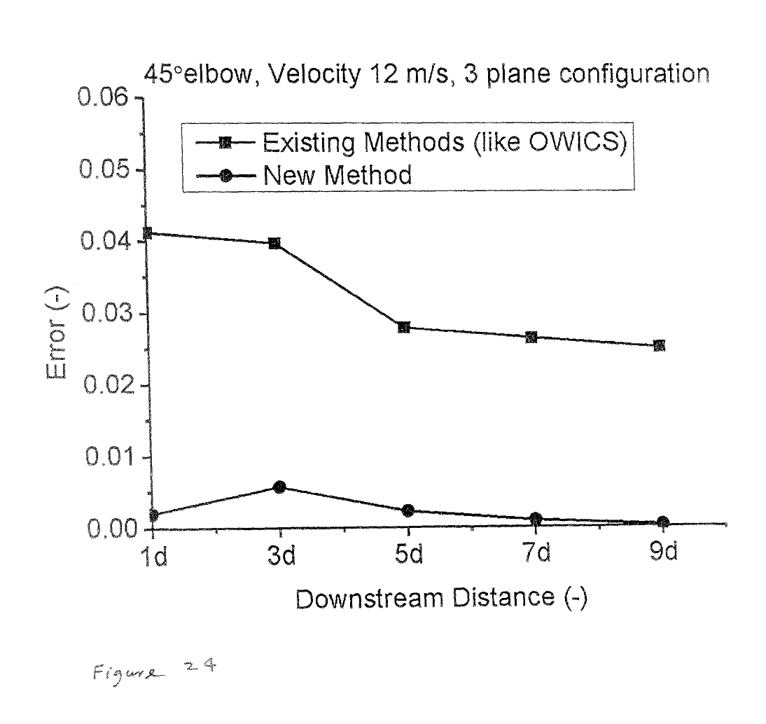

FIG. 24 illustrates flow rate measurement error graphs for a sixth flow system,

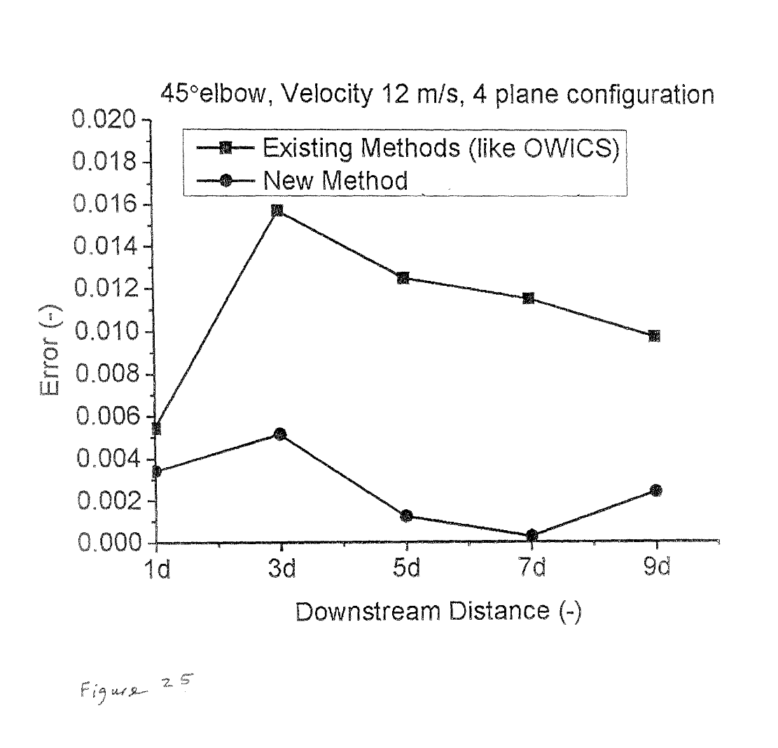

FIG. 25 illustrates flow rate measurement error graphs for a seventh flow system,

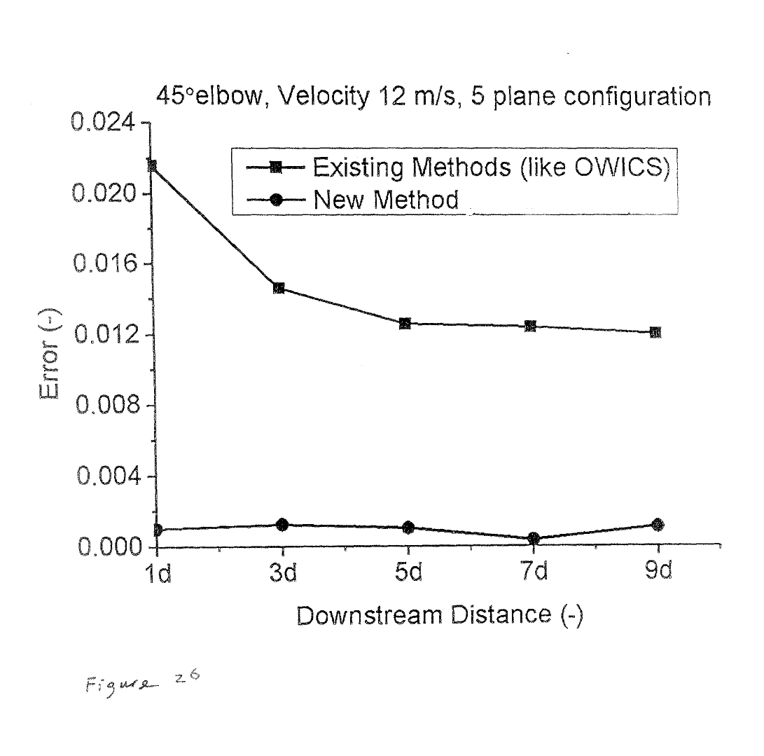

FIG. 26 illustrates flow rate measurement error graphs for a eighth flow system,

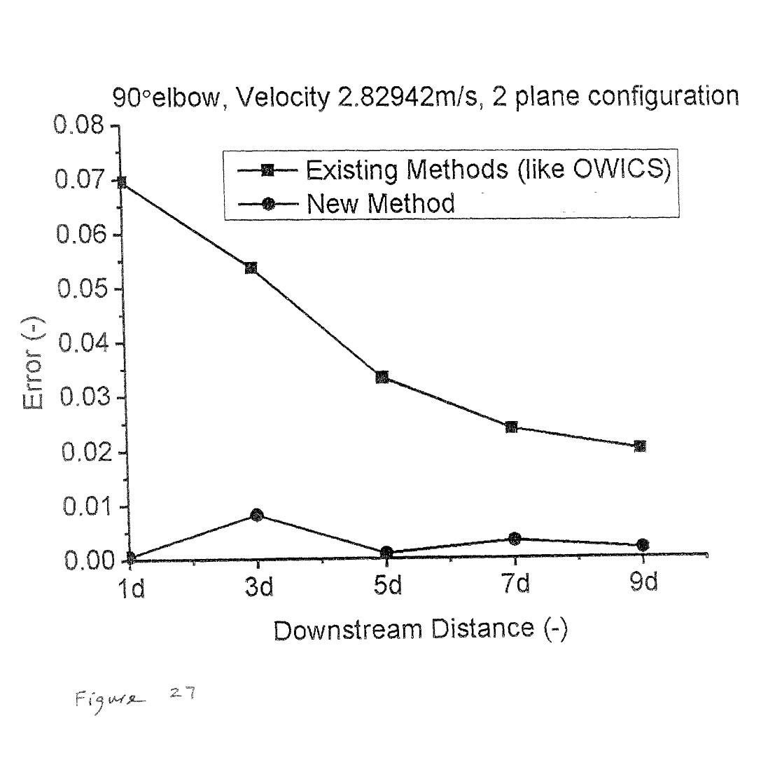

FIG. 27 illustrates flow rate measurement error graphs for a ninth flow system,

FIG. 28 illustrates flow rate measurement error graphs for a tenth flow system,

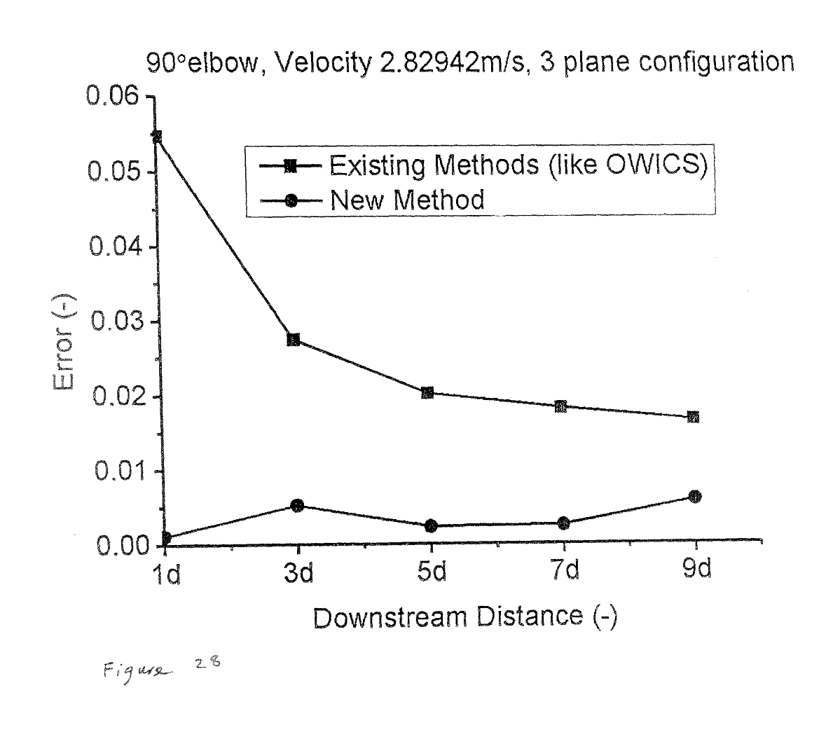

FIG. 29 illustrates flow rate measurement error graphs for an eleventh flow system,

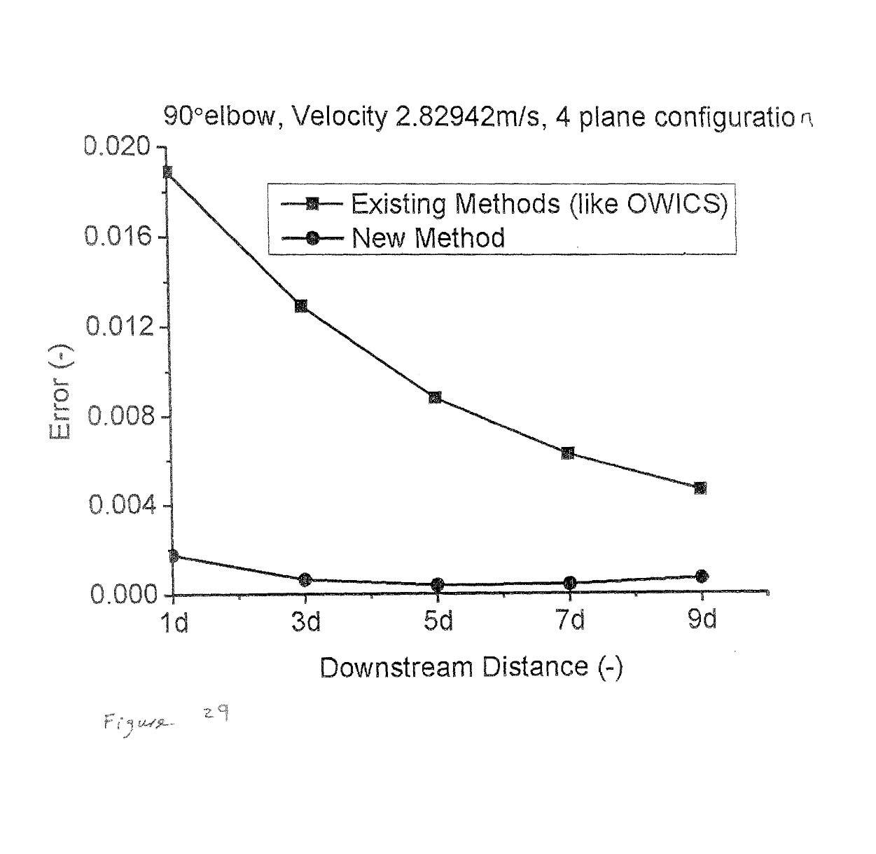

FIG. 30 illustrates flow rate measurement error graphs for a twelfth flow system,

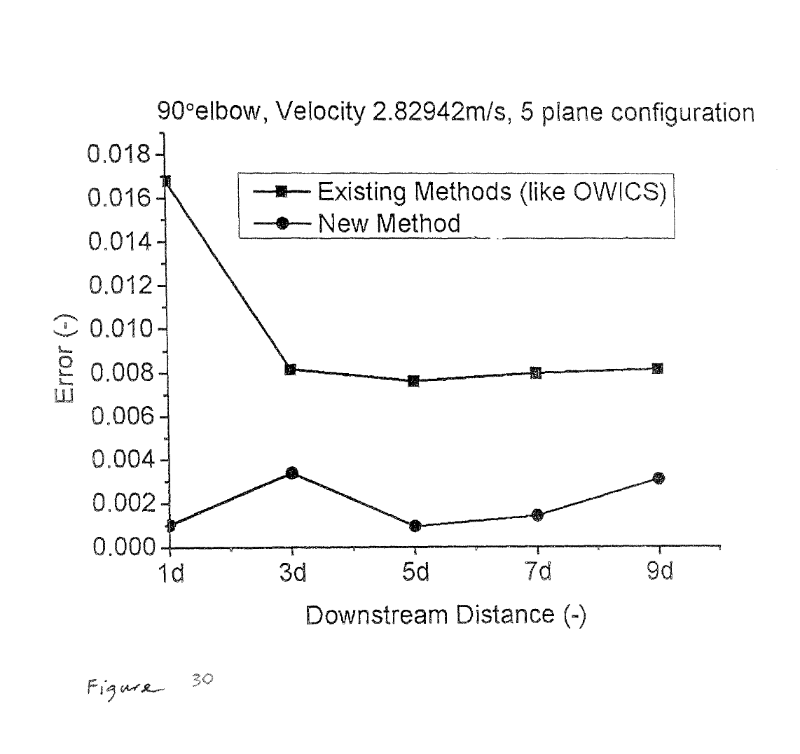

FIG. 31 illustrates flow rate measurement error graphs for a thirteen flow system,

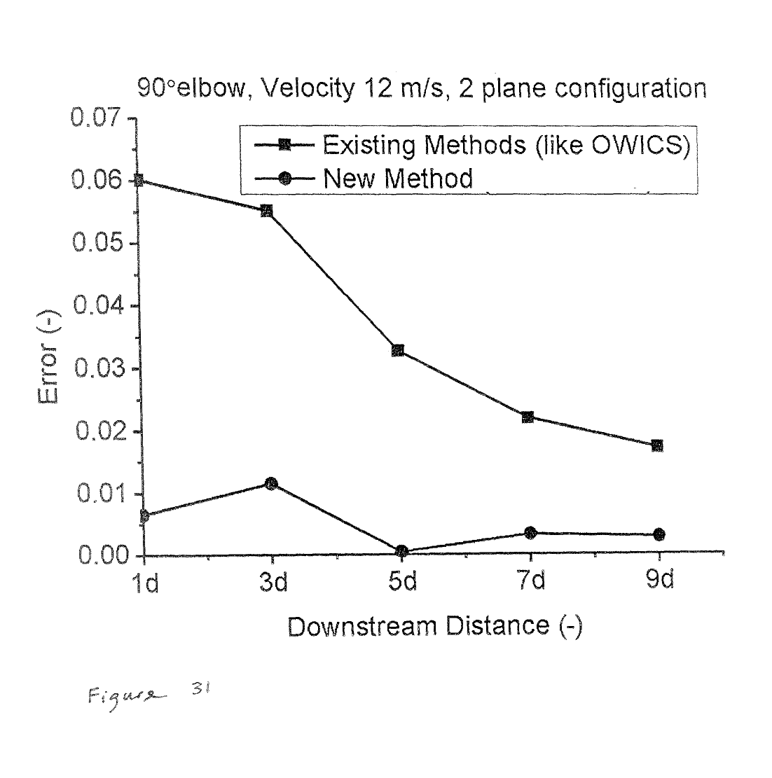

FIG. 32 illustrates flow rate measurement error graphs for a fourteen flow system,

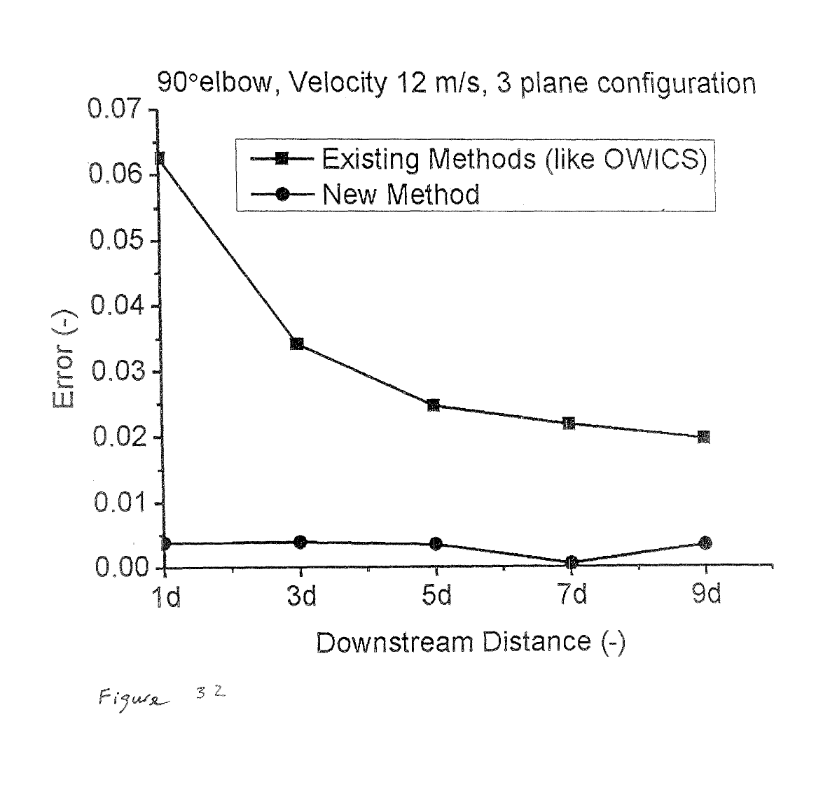

FIG. 33 illustrates flow rate measurement error graphs for a fifteen flow system,

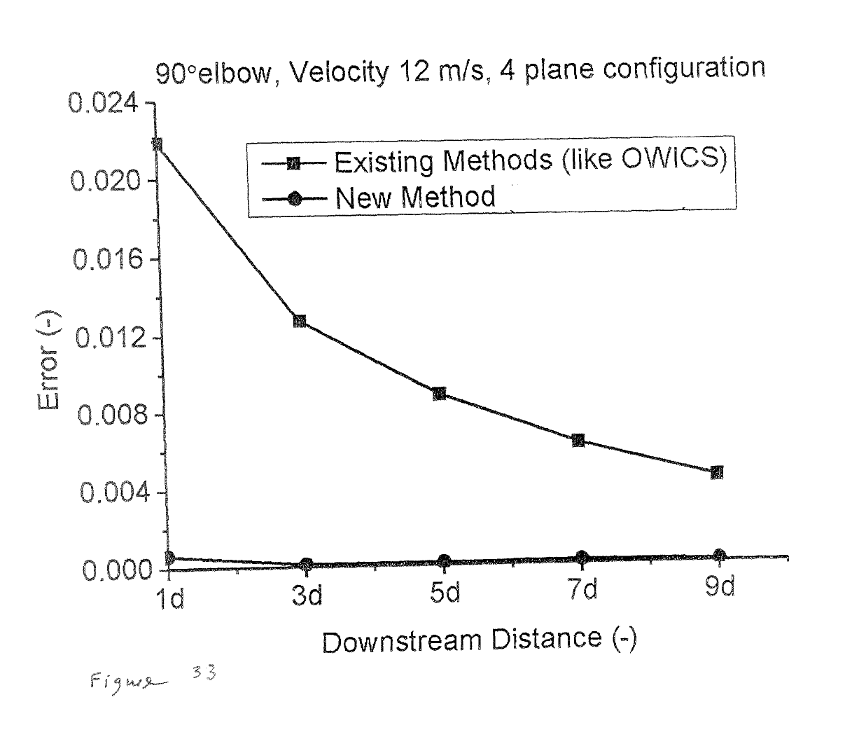

FIG. 34 illustrates flow rate measurement error graphs for a sixteen flow system,

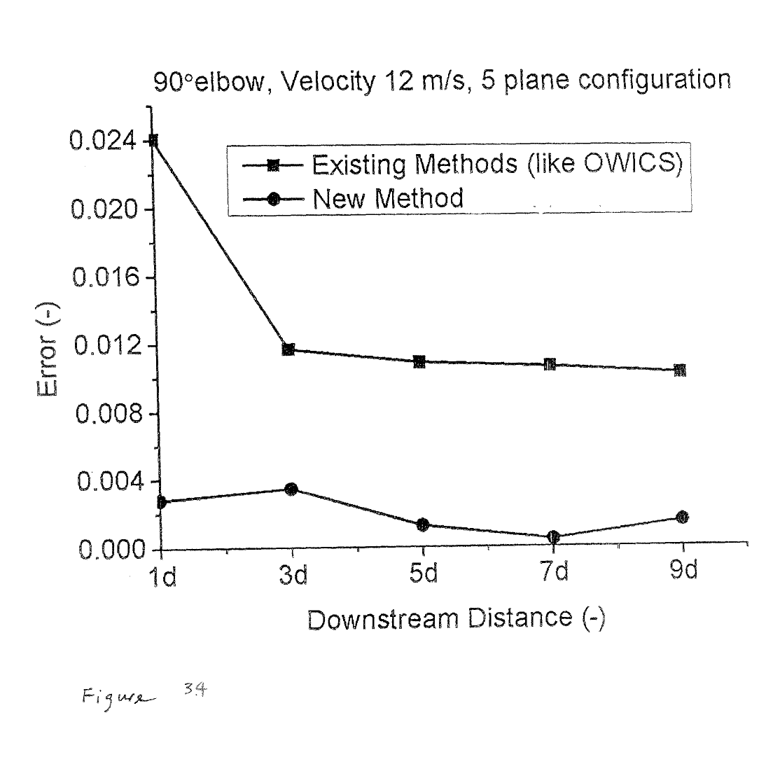

FIG. 35 illustrates a flow profile of an elbow fluid conduit,

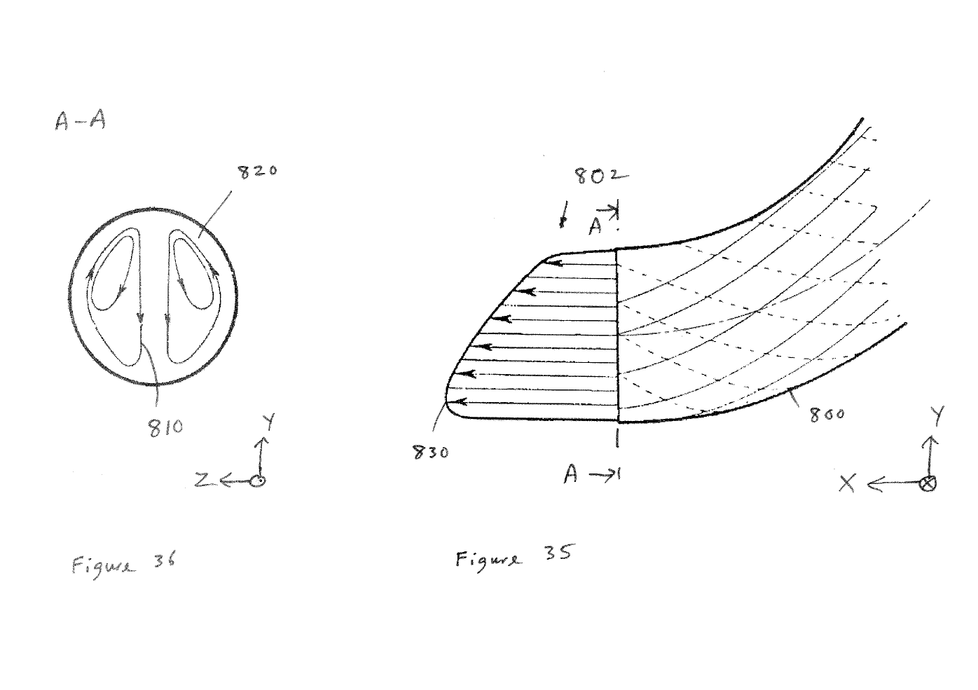

FIG. 36 illustrates a cross-sectional view of the flow profile of FIG. 35,

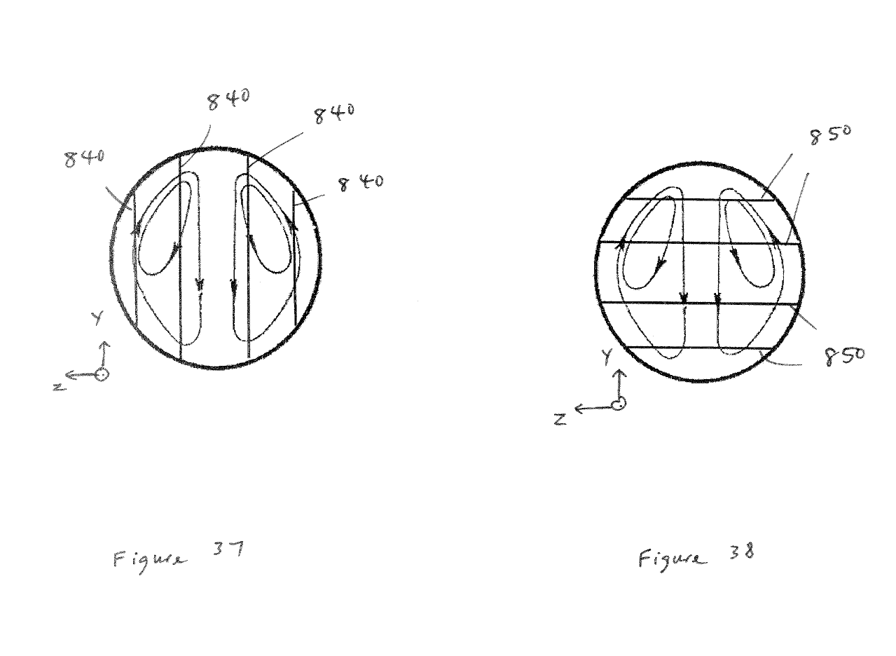

FIG. 37 illustrates the cross-sectional view of FIG. 36 with vertical measurement planes,

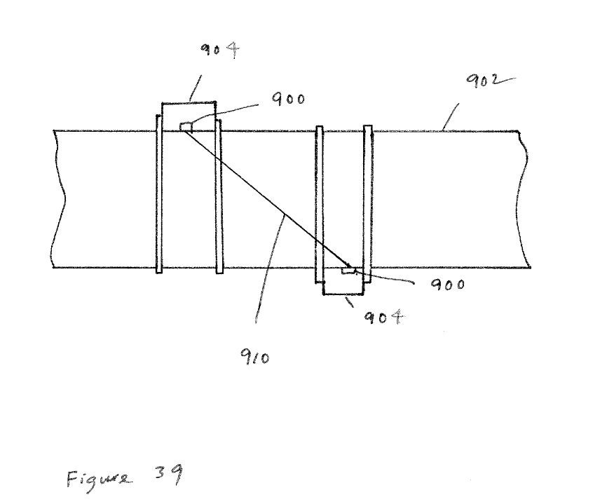

FIG. 38 illustrates the cross-sectional view of FIG. 36 with horizontal measurement planes,

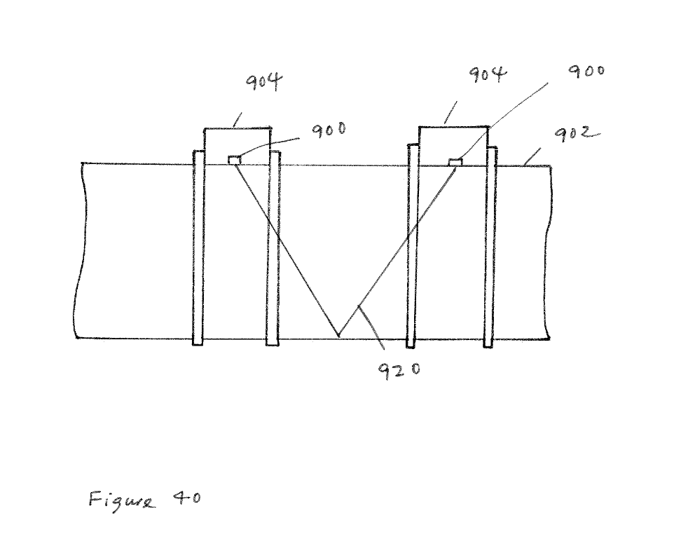

FIG. 39 illustrates a clamped acoustic transducer pair with a direct measurement path,

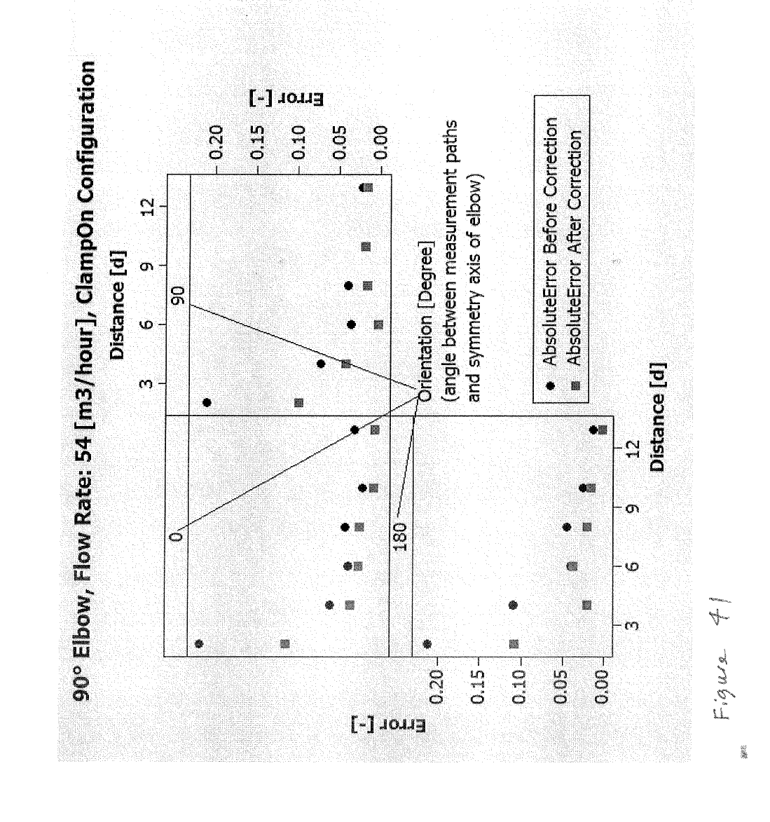

FIG. 40 illustrates a clamped acoustic transducer pair with a reflected measurement path, and

FIG. 41 illustrates flow measurements for the acoustic transducer pair with different relative orientations and with different positions.

Some parts of the embodiments, which are shown in the Figures, have similar parts. The similar parts have the same names or similar part numbers with a prime symbol or with an alphabetic symbol. The description of such similar parts also applies by reference to other similar parts, where appropriate, thereby reducing repetition of text without limiting the disclosure.

The first embodiment relates to a system for determining a rate of fluid flow in a conduit. In general terms, the system includes a look up table with correction operations for a range of conduit configurations. A user interface is used to select which conduit configuration a flow sensor of the system is being installed into. The flow sensor provides measurement values to electronics, which then outputs a corrected output signal based on the selected configuration correction operation in the lookup table, to estimate the average flow velocity of the conduit at the flow sensor location. This means that the system can provide an accurate estimate of the average flow velocity in that specific location without the need for costly on-site calibration.

Referring to FIG. 1, there is shown a system 20 for determining a rate of fluid flow in a pressurized conduit. The system 20 includes a user interface 22, an information repository 24, a fluid flow sensor 26 and a microcontroller 28. The microcontroller 28 is connected to user interface 22, to the information repository 24, and to fluid flow sensor 26.

The user interface 22 is provided for determining installation site parameters for the system 20. Determining installation site parameters includes at least one of a user entering the parameters and automatic measurement of the parameters. The user interface 22 can be in the form of a display panel, and can be a touch-screen panel. The user interface 22 may be a Personal Computer (PC), a computing tablet, a computing notebook, and the like. The installation site parameters include at least one selected from, for example, geometrical run of the conduit, disturbance element, conduit diameter, distance from disturbance, and so forth. Examples of disturbance elements are shown in FIGS. 2 and 3. In one embodiment, the user interface 22 is accessible via an online URL, which enables a user to remotely connect to the system 20. The user interface 22 can be in a form of a software program, which runs on a mobile computing device such as, for example, a computing laptop, a computing tablet, a computing mobile phone and the like.

In another embodiment, the user interface 22 includes dip switches on the outside of the casing, where the selected switch on/off combination corresponds to a particular conduit configuration. In another embodiment as shown in FIG. 7, the user interface 22 is in a form of a display panel and includes alphanumeric menus, list box menus, combo box menus, check box menus, pull down menus 200, graphical selection menus 300, 500, and direct data entry fields 400. It should be appreciated that the user interface 22 as shown in FIG. 7 enables convenient input of the installation site parameters.

In FIG. 7, the pull down menu 200 shows a text selection of available installation site parameters. A first graphical selection menu 300 shows a diagrammatic selection of available installation site parameters. A second graphical selection menu 500 shows a diagrammatic positioning of an installed flow meter to in the pressurized conduit. The direct data entry field 400 shows entry of “D” and “N”, whereby “D” refers to a diameter of the conduit while “N” refers to a factor of diameters. Alternatively, the user interface 22 can be operated by voice whereby voice commands are processed and a voice recognition system determines an input using, for example, the alphanumeric menus, the list box menus, the combo box menus, the check box menus, the pull down menu 200, the graphical selection menus 300, 500 and the direct data entry field 400 of the user interface 22.

It should be appreciated that the aforementioned embodiments of the user interface 22 can be combined in any combination, such that the user interface 22 can be of the form of at least, for example, graphical, electronic, mechanical, mechatronic and the like.

The information repository 24 is a memory for storing a plurality of correction/calibration operations. The plurality of correction/calibration operations is obtained using simulations. Each of the correction/calibration operations are associated with at least one of respective installation site parameters and real-time fluid velocities at installation site. These correction/calibration operations can be, for example, values, matrixes, functions, algorithms, real-time simulations, physical models, surrogate models and the like. These correction/calibration operations can be, generally, any kind of mathematical operation, which corrects or modifies the measured values in order to increase the flow rate accuracy.

The fluid flow sensor(s) 26 measure real-time fluid velocities at particular location(s) within the conduit at the installation site. The flow sensor 26 is part of a flow meter that may measure directly or indirectly, flow velocities using various technologies such as, for example, mechanical flow meters, optical flow meters, ultrasonic flow meters, differential pressure meters, positive displacement meters, inferential meters, oscillatory flow meters, thermal mass flow meters, electromagnetic flow meters, vortex flow meters, Coriolis mass flow meters and so forth depending on the application requirements.

The microcontroller 28 applies the selected correction operation from the information repository 24 to the measured value to obtain the estimated average flow velocity.

Referring to FIGS. 2 and 3, there are shown examples of different installation configurations. FIG. 2(a) shows configurations where the system 20 is installed upstream from a distortion element(s) while FIG. 2(b) shows configurations where the system 20 is installed downstream from a distortion element(s).

In FIG. 2(a), (i) denotes the system 20 installed in a straight pipe; (ii) denotes the system 20 installed in before a 90 degree elbow; (iii) denotes the system 20 installed before two 90 degree elbows in the same plane; (iv) denotes the system 20 installed before two 90 degree elbows in different planes; (v) denotes the system 20 installed before a pipe expansion; (vi) denotes the system 20 installed before a pipe contraction; (vii) denotes the system 20 installed before a valve; and (viii) denotes the system 20 installed before a pump.

In FIG. 2(b), (i) denotes the system 20 installed in a straight pipe; (ii) denotes the system 20 installed after a 90 degree elbow; (iii) denotes the system 20 installed after two 90 degree elbows in the same plane; (iv) denotes the system 20 installed after two 90 degree elbows in different planes; (v) denotes the system 20 installed after a pipe contraction; (vi) denotes the system 20 installed after a pipe expansion; (vii) denotes the system 20 installed after a valve; and (viii) denotes the system 20 installed after a pump.

Each of the sixteen configurations has a set of associated correction/calibration operations stored in the information repository 24. It should be appreciated that there can be more than the sixteen configurations shown in FIGS. 2 and 3. Each of the associated correction/calibration operations was obtained using simulations. It should be appreciated that any combination of the configurations shown in FIG. 2 may also have associated correction/calibration operations stored in the information repository 24, although there may be other combinations other than those involving the sixteen configurations.

Referring to FIG. 4, there is a simulation of a 90-degree elbow type disturbance in a conduit. The “D” denoted in the FIG. 4 refers to the diameter of the conduit. Clearly, the velocity profile is not symmetrical and varies substantially depending on distance from the bend. Evidentially, location of the flow sensor 26 within the profile is critical to the output accuracy.

FIG. 5 shows exemplary correction operations for one particular velocity measurement. Each point along each correction operation curve is an entry in the lookup table stored in the information repository 24.

FIG. 6 illustrates a method 50 for determining a rate of fluid flow in a pressurized conduit according to the second embodiment. The method 50 includes a step 52 of measuring real-time fluid flow at an installation site. The flow rate is measured using at least one flow sensor 26 and the data being collected will be analysed. Parameters of the installation site are determined in a step 54. It should be appreciated that the step of measuring of real-time velocities and the step 54 of determination of installation site parameters may be either simultaneous or done in any order. The determination of installation site parameters includes at least one of a user entering the parameters and automatic measurement of the parameters. Subsequently, an associated correction/calibration operation is obtained in a step 56 based on analysis of at least one of the directly or indirectly measured velocities and the parameters at the installation site. Finally, the corrected rate of flow is estimated is a step 58 by applying the correction for the selected installation site to the real-time fluid velocities.

The system 20 allows a user to select and enter on-site specific parameters related to any installation location based on predetermined conduit configurations parameters without the requirement of any additional calibration in order to achieve corrected flow rates with the highest accuracy. Furthermore, it should be appreciated that the system 20 is not restricted to either a certain minimum length of straight pipes or a certain set of disturbances but can be used in a much wider field of applications without adversely affecting accuracy of the flow rate. The present application does away with the need for additional (and expensive) calibrations after the installations.

Whilst there has been described in the foregoing description preferred embodiments of the present application, it will be understood by those skilled in the technology concerned that many variations or modifications in details of design or construction may be made without departing from the present application.

For example, the microcontroller 28 might be substituted with analogue circuitry depending on the application requirements. Further, in some applications some hardwire connections may be replaced with wireless connections. For example, the user interface 22 may run on a mobile computing device such as, for example, a laptop, a tablet, or a mobile phone, and wirelessly connect to the system 20 to set the conduit configuration setting. The correction operation (each being calculated in a prior instance either on a server or an online application) lookup table may be retained within the installer's user interface 22 and the specific selected correction operation for that specific conduit configuration may simply be uploaded to the system 20. The flow sensor 26 may wirelessly connect to the microcontroller 28. In a further alternative each flow sensor 26 may be connected to a network either wired or wirelessly. A central controller may store a lookup table for the conduit configuration setting for each flow sensor 26 from a flow meter of various technologies such as, for example, mechanical flow meters, optical flow meters, ultrasonic flow meters, differential pressure meters, positive displacement meters, inferential meters, oscillatory flow meters, thermal mass flow meters, electromagnetic flow meters, vortex flow meters, Coriolis mass flow meters, and so forth. The correction operation may be applied locally or remotely. The wireless connection may be implemented using Bluetooth, WiFi, GPRS etc. The lookup table, correction operations and/or specific conduit configuration may be also be updated periodically or regularly with new data. It should also be appreciated that only the flow sensor 26 is located at the installation site while all other components of the system 20 may be located away from the installation site, and operationally connectable to each other via either wireless signals or data networks.

FIG. 8 shows a series 100 of conduits. The conduit series 100 includes an acoustic flow meter 103.

The acoustic flow meter 103 has a first end and a second end. The first end is connected to a first end of a straight cylindrical conduit 105, which has a length Lc and an internal diameter Dc. A second end of the straight cylindrical conduit 105 is connected to an elbow conduit 107. Referring to the second end of the acoustic flow meter 103, it is connected to another straight cylindrical conduit 109.

In use, a fluid completely fills the elbow conduit 107, the first straight cylindrical conduit 105, the acoustic flow meter 103, and the second straight cylindrical conduit 109. The fluid flows from the elbow conduit 107 to the first straight cylindrical conduit 105, to the acoustic flow meter 103, and to the second straight cylindrical conduit 109.

FIG. 9 shows a spool piece 111 of the acoustic flow meter 103. As seen in FIG. 10, the spool piece 111 is enclosed by a transducer casing 114, wherein the transducer casing 114 holds a plurality of attachable transducers, namely two pairs of transducers 115a, two pairs of transducers 115b, two pairs of transducers 115c, two pairs of transducers 115d, and two pairs of transducers 115e.

The spool piece 111 has a cylindrical body 116 with two circular ends. Each circular end has a flange 118. The cylindrical body 116 has a plurality of openings with pre-determined positions. The openings include four first openings 119a, four first openings 119b, four first openings 119c, four first openings 119d, and four first openings 119e. The spool piece 111 has a length Lm and an internal diameter Dm.

The transducer casing 114 surrounds the cylindrical body 116 and it holds the transducers 115a, 115b, 115c, 115d, and 115e. The transducers 115a are placed in the pre-determined positions of the openings 119a with pre-determined orientations. Similarly, the transducers 115b are placed in the pre-determined positions of the openings 119b with pre-determined orientations and the transducers 115c are placed in the pre-determined positions of the openings 119c with pre-determined orientations. The transducers 115d are placed in the pre-determined positions of the openings 119d with pre-determined orientations. The transducers 115e are placed in the pre-determined positions of the openings 119e with pre-determined orientations.

As seen in FIG. 10, the transducer casing 114 has five parallel acoustic planes 120a, 120b, 120c, 120d, and 120e. Each acoustic plane 120a, 120b, 120c, 120d, and 120e has two pairs of the transducers 115a, 115b, 115c, 115d, and 115e, respectively. For easier reference, FIG. 11 illustrates the transducers for one acoustic plane 120a, which also applies for other acoustic planes 120b, 120c, 120d, and 120e.

Each pair of the transducers 115a, 115b, 115c, 115d, and 115e are oriented such that the corresponding transducers 115a, 115b, 115c, 115d, and 115e have an acoustic path 125a, 125b, 125c, 125d, and 125e, respectively. The acoustic paths 125a, 125b, 125c, 125d, and 125e extend between the corresponding transducers 115a, 115b, 115c, 115d, and 115e. Each acoustic plane 120a, 120b, 120c, 120d, and 120e has two acoustic paths 125a, 125b, 125c, 125d, and 125e, respectively, which meet or cross each other. FIG. 11 also illustrates the crossing of acoustic path for just the transducers 115a, for easier illustration. This illustration can be applied to other transducers, 115b, 115c, 115d, and 115e.

In use, the spool piece 111 and the cylindrical conduit 109 also allow a fluid to pass through them.

The elbow conduit 107 serves as a flow disturbance element for a fluid that passes through the elbow conduit 107, from one end of the elbow conduit 107 to another end of the elbow conduit 107. The disturbance element introduces flow disturbance such as vortex flow, swirl and other non-uniform or non-axial components into the fluid flow.

The transducer casing 114 provides housings with pre-determined positions for holding the transducers 115a, 115b, 115c, 115d, and 115e and for keeping the transducers 115a, 115b, 115c, 115d, and 115e in place at the pre-determined positions and at the pre-determined orientations.

The transducers 115a, 115b, 115c, 115d, and 115e act as ultrasonic transceivers. Each pair of the transducers 115a, 115b, 115c, 115d, and 115e are oriented such one of the transducer 115a, 115b, 115c, 115d, and 115e transmits the corresponding acoustic path 125a, 125b, 125c, 125d, and 125e while the other transducer 115a, 115b, 115c, 115d, and 115e receives the acoustic signal and also measures the acoustic signal. The transducers 115a, 115b, 115c, 115d, and 115e then switch roles. The signal measures are later averaged to eliminate interfering signals or noise. In other words, the measurements are done in two opposing directions, namely in the upstream direction and in the downstream direction.

The transducer 115a, 115b, 115c, 115d, and 115e also has a aperture directed to the corresponding transducer 115a, 115b, 115c, 115d, and 115e such that the transmitted acoustic signal has a narrow width, whereby essentially preventing other transducer 115a, 115b, 115c, 115d, and 115e from reading or measuring the transmitted acoustic signal. This aperture also eliminates or reduces echo from the transmitted acoustic signal.

The transducer pairs also transmit their acoustic signals in a staggered fashion. When one transducer pair is transmitted the acoustic signal, the other transducer pairs are not transmitted for not interfering with the transmitted signal of the said transducer pair. Put differently, the transducer pairs transmit the acoustic signals one at a time.

A flow of fluid in the spool piece 111 would alter the time taken for the acoustic signal to reach the receiving transducer 115a, 115b, 115c, 115d, and 115e. The fluid flows from an upstream transducer to a downstream transducer. A downstream transducer, which receives an acoustic signal from an upstream transducer, would receive the acoustic signal earlier. Likewise, an upstream transducer, which receives an acoustic signal from a downstream transducer, would receive the acoustic signal later. By measuring the difference time in receiving the acoustic signal, one can compute the flow rate of the fluid.

In a general sense, the ultrasonic transceivers are a form of sonic transceivers. The transducers 115a, 115b, 115c, 115d, and 115e are a form of the fluid flow sensor.

A method of using the acoustic flow meter 103 includes a method for generating flow profile, a method of generating transducer readings, and a method of operating the acoustic flow meter 103. These methods are described below.

The first two methods generate a flow rate relational data set, which is used by the third method to compute a flow rate.

FIG. 12 shows a flow chart 130 of a method for generating flow profile by simulation.

The flow chart 130 includes a step 131 of selecting a flow rate of a fluid that flows through the conduit series 100.

After this, a step 132 of a user selecting a type of flow disturbance element on the user interface 22 is performed. Examples of the type disturbance element include a single elbow conduit type and a double elbow conduit type. The user interface 22 then transmits the received selection of the type of disturbance element to the microcontroller 28.

The user also selects a position and an orientation of the flow disturbance element on the user interface 22, in a step 134. The user interface 22 also transmits the received position and the received orientation of the flow disturbance element to the microcontroller 28.

The position of the flow disturbance element is defined with respect to a position of the flow meter 103. The position of the flow disturbance element with respect to the position of flow meter 103 can be derived from the absolute position of the flow disturbance element and the absolute position of the flow meter 103.

The position of the elbow conduit 107 relative to the position of the flow meter 103 determines the effect of disturbance by the conduit 107 on the flow velocity profile of the fluid at the flow meter 103. If the elbow conduit 107 is positioned near to the flow meter 103, the elbow conduit 107 would have a greater influence on the flow velocity profile of fluid at the flow meter 103.

Similarly, the orientation of the flow disturbance element is defined with respect to an orientation of the flow meter 103. The orientation of the flow disturbance element with respect to the orientation of flow meter 103 can be derived from the absolute orientation of the flow disturbance element and the absolute orientation of the flow meter 103.

The orientation of the elbow conduit 107 relative to the orientation of the flow meter 103 also affects the flow velocity profile of the fluid at the flow meter. This change of flow velocity profile would in turn affect the readings of the transducers 115a, 115b, 115c, 115d, and 115e. If the relative orientation of the elbow conduit 107 is not taken into account, this effect would result in an error in the transducer readings.

After this, the microcontroller 28 simulates flow profiles of the fluid at the flow meter 103 according to the selected type of a flow disturbance element and according to the selected position and orientation of the flow disturbance element, in a step 136. The simulation uses a mathematical model or an algorithm that generates the flow profile according to a type of flow disturbance element and according to a position and an orientation of the flow disturbance element. The type of flow disturbance element as well as the position and the orientation of the flow disturbance element serve as parameters for the mathematical model or the algorithm to generate the flow profile.

The above steps are repeated for various flow rates and various types of flow disturbance elements with various positions and various orientations of the flow disturbance elements.

The flow disturbance element introduces a flow disturbance to the fluid flow. Different types of disturbance element would introduce different types of flow disturbance. Furthermore, the flow disturbance would also change as it propagates downstream along the flow of fluid.

This flow disturbance is then experienced by a flow meter, which is placed downstream from the flow disturbance element, wherein the flow disturbance, if not considered, would also cause the flow rate measured by the flow meter to have an error.

In short, the flow disturbance experienced at the flow meter is dependent on the type of disturbance element placed upstream, dependent on the position of the disturbance element with respect to the position of the flow rate measurement area and also dependent on the orientation of the disturbance element.

The microcontroller 28 then stores the simulated flow profile in a flow profile relational data set, in a step 139. The microcontroller 28 has an information repository 24, which serves as a memory unit for storing data.

The flow rate relational data set comprises flow rate data, flow disturbance element type data with flow disturbance element position data and with flow disturbance element orientation data and their corresponding simulated flow profile data. Each flow rate data, together with a flow disturbance element type data, with a disturbance element position data and with an orientation disturbance element data has a corresponding simulated flow profile data.

In a general sense, other methods of generating the flow profile data are possible. The flow profile data can also be generated by measurements. In another words, flow measurements are taken to derive the flow profile.

FIG. 13 shows a flow chart 150 of a method of generating transducer readings by simulation.

The flow chart 150 is performed after the flow chart 130 of FIG. 12.

The flow chart 150 include a step 153 of selecting a flow profile corresponding to a particular flow rate and corresponding to a particular flow disturbance element type with a particular flow disturbance element position and with a particular flow disturbance element orientation.

The user later selects a position and an orientation of a transducer pair on the user interface 22, in a step 156. The position and the orientation of the transducer pair define an acoustic path as well as an acoustic plane of the transducer pair. The user interface 22 transmits the received position and orientation of a transducer pair to microcontroller 28.

The microcontroller 28 then simulates a reading of the transducer pair according to the above selected flow rate and according to the selected position and orientation of the transducer pair, in a step 159.

The microcontroller 28 afterwards stores the simulated transducer reading with the flow rate in a flow rate relational data set that includes data from the above flow profile relation data set, in a step 162.

The above steps are repeated for various flow rates and various positions with various orientations of the transducer pair.

The flow rate relational data set includes flow rate data, flow disturbance element type data with corresponding flow disturbance element position data and with corresponding flow disturbance element orientation data, transducer pair position data with corresponding transducer pair orientation data, and with corresponding simulated transducer reading data.

FIG. 14 shows a flow chart 170 of a method of operating the acoustic flow meter 103 using the flow rate relational data, which is generated by the steps of the flow chart 150 of FIG. 13.

The steps of the flow chart 170 are performed after the flow chart 150. The flow chart 170 includes a step 173 of the user interface 22 receiving a selection of a type of fluid flow disturbance element and receiving a position and orientation of the disturbance element from a user. The user interface 22 then transmits the received selection of the type of disturbance element and the received position and orientation of the disturbance element to the microcontroller 28.

A step 179 of the user providing positions and orientations of the transducers 115a, 115b, 115c, 115d, and 115e to the user interface 22 is then performed. The user interface 22 later transmits the received positions and orientations of the transducers 115a, 115b, 115c, 115d, and 115e to the microcontroller 28.

The microcontroller 28 afterward obtains measurement readings of the fluid from the transducers 115a, 115b, 115c, 115d, and 115e, in a step 182.

The microcontroller 28 then determines the flow rate of the fluid in a step 185. The flow rate is determined using the flow rate relational data set according to the selected type of fluid flow disturbance element, to the received position and orientation of the disturbance element, to the received positions and orientations of the transducers 115a, 115b, 115c, 115d, and 115e, and to the measurement readings of the fluid.

The microcontroller 28 interpolates or extrapolates the data of the flow rate relational data set to determine the flow rate.

In a general sense, the interpolation or the extrapolation is a form of “pseudo inverse” is to compute a best fit solution to determine the flow rate.

From a top level point of view, the type of the disturbance element with its position and with its orientation represents 3 input parameters while the positions of the transducers 115a, 115b, 115c, 115d, and 115e with its corresponding orientations represents 2 input parameters.

The flow rate relational data set with the flow rate data, the flow disturbance element type data with its corresponding flow disturbance element position data and with its corresponding flow disturbance element orientation data, and the transducer pair position data with its corresponding transducer pair orientation data, and with its corresponding simulated transducer reading data represents six related data sets.

The five input parameters are thus sufficient to derive the flow rate from the flow rate relational data set, which has six related data sets.

The microcontroller 28 later transmits the determined flow rate to the user interface 22 and to an external output device.

FIG. 15 shows flow profiles at the spool piece 11 of the flow meter 103 of FIG. 10.

FIG. 16 shows a data set of flow rates and transducer readings of the transducers 115a, 115b, 115c, 115d, and 115e of FIG. 10. The data set is produced using the flow chart 130 of FIG. 12 and the flow chart 150 of FIG. 13. The flow disturbance type is an elbow, which is oriented such that it causes the fluid to flowing vertically before flowing horizontally. The flow disturbance type is positioned 0.5 metre away from the flow meter 103. The transducers 115a, 115b, 115c, 115d, and 115e are oriented horizontally.

FIG. 17 shows transducers readings of the flow meter 103.

FIG. 18 shows a flow chart 600 of another method of using the flow meter 103 to measure a flow rate of a fluid in a flow conduit.

The flow chart 600 includes a step of a user selecting a flow rate of the fluid and selecting a type of flow disturbance element with its corresponding position and with its corresponding orientation, wherein the flow disturbance element is placed upstream from the flow meter 103.

After this, a volume flux Q_CFD of the fluid is simulated using a Computational Fluid Dynamics (CFD) method according to the above selected type, position, and orientation of the flow disturbance element using an external computer, in a step 602. The CFD method uses numerical methods and algorithms, such as a Finite Element Method, which generally generates accurate results while requiring a large amount of computing resources.

The above simulation also simulates flow velocities at pre-determined positions of the acoustic planes 120a, 120b, 120c, 120d, and 120e of the transducers 115a, 115b, 115c, 115d, and 115e of the flow meter 103. Following this, corresponding average or mean flow velocities Va, Vb, Vc, Vd, and Ve of the simulated flow velocities are then computed for different positions of the acoustic planes 120a, 120b, 120c, 120d, and 120e of the flow meter 103. The mean flow velocities Va, Vb, Vc, Vd, and Ve are illustrated in FIG. 10.

A volume flux Q_OWICS of the fluid is later simulated using an “Optimal Weighted Integrated For Circular Sections” (OWICS) method according to the above computed mean flow velocities V_CFD, by the microcontroller 28, in a step 609.

The OWICS method generally requires less computing resources while producing less accurate results.

The volume flux Q_OWICS with the corresponding mean flow velocities Va, Vb, Vc, Vd, and Ve and its corresponding positions are later stored in a relational data set of a computer memory.

After this, an error E of the simulated volume flux Q_OWICS in relation to the simulated volume flux Q_CFD is then computed, in a step 612.

The error E acts as a compensation factor to derive essentially the volume flux Q_CFD from the volume flux Q_OWICS. The simulated volume flux Q_CFD is often more accurate than the simulated volume flux Q_OWICS. However, the computing resource to use the CFD to simulate the volume flux Q_CFD is also much greater than the computing resource to use the OWICS to simulate the volume flux Q_OWICS. The use of the error E to derive the volume flux Q_CFD from the volume flux Q_OWICS thus has an advantage of producing a more accurate volume flux with less computing resources.

Following this, the error E with the corresponding volume flux Q_OWIC, and the corresponding type, position, and orientation of the flow disturbance element are stored in a relational data set in the computer memory.

The above steps are later repeated for different flow rates and for different types of flow disturbance element with different corresponding positions and with different corresponding orientations.

To operate the flow meter 103 to measure a flow rate of a fluid, a user then fixes the flow meter 103 to a conduit, wherein the fluid is flowing through. The user then inputs a type data of flow disturbance element together with its position data and with its orientation data to the user interface 22. The flow disturbance element is placed upstream from the flow meter 103.

The user also inputs positions and orientations of the transducers 115a, 115b, 115c, 115d, and 115e of the flow meter 103 to the interface 22.

The micro-controller 28 then obtains flow measurement readings from the transducers 115a, 115b, 115c, 115d, and 115e.

The micro-controller 28 later determines mean readings Va, Vb, Vc, Vd, and Ve from the flow measurement readings.

After this, the micro-controller 28 retrieves the corresponding volume flux Q_OWICS from the data set according to the positions and the orientations of the transducers 115a, 115b, 115c, 115d, and 115e, which are inputted by the user, and according to the flow measurement readings obtained from the transducers 115a, 115b, 115c, 115d, and 115e.

In a special embodiment, the above step of retrieving the volume flux Q_OWICS is replaced by a step of simulating the volume flux Q_OWICS. The simulation uses the OWICS method to generate the volume flux Q_OWICS according to the positions and the orientations of the transducers 115a, 115b, 115c, 115d, and 115e, which are inputted by the user, and according to the flow measurement readings obtained from the transducers 115a, 115b, 115c, 115d, and 115e.

The micro-controller 28 afterward retrieves the error E from the relational data set according to the above retrieved volume flux Q_OWICS and according to the type, position and orientation of the flow disturbance element, which is provided by the user.

The volume flux of the fluid is then determined according to the above error E and the above volume flux Q_OWICS.

FIGS. 18 to 33 show different flow rate measurement error graphs for different fluid systems that use the above methods of using the acoustic flow meter 103.

Each figure shows one flow rate measurement error graph using the above method the above embodiment and another flow rate measurement error graph using a known method. These graphs show that flow rate measurement errors of the above methods are less than the flow rate measurement errors of the known method.

FIG. 19 shows flow rate measurement error graphs for one system, wherein the system has a 45-degree elbow disturbance element, a flow rate of 2.82942 meter/second, and an acoustic flow meter with two transducer acoustic planes.

FIG. 20 shows flow rate measurement error graphs for one system, wherein the system has a 45-degree elbow disturbance element, a flow rate of 2.82942 meter/second, and an acoustic flow meter with three transducer acoustic planes.

FIG. 21 shows flow rate measurement error graphs for one system, wherein the system has a 45-degree elbow disturbance element, a flow rate of 2.82942 meter/second, and an acoustic flow meter with four transducer acoustic planes.

FIG. 22 shows flow rate measurement error graphs for one system, wherein the system has a 45-degree elbow disturbance element, a flow rate of 2.82942 meter/second, and an acoustic flow meter with five transducer acoustic planes.

FIG. 23 shows flow rate measurement error graphs for one system, wherein the system has a 45-degree elbow disturbance element, a flow rate of 12 meter/second, and an acoustic flow meter with two transducer acoustic planes.

FIG. 24 shows flow rate measurement error graphs for one system, wherein the system has a 45-degree elbow disturbance element, a flow rate of 12 meter/second, and an acoustic flow meter with three transducer acoustic planes.

FIG. 25 shows flow rate measurement error graphs for one system, wherein the system has a 45-degree elbow disturbance element, a flow rate of 12 meter/second, and an acoustic flow meter with four transducer acoustic planes.

FIG. 26 shows flow rate measurement error graphs for one system, wherein the system has a 45-degree elbow disturbance element, a flow rate of 12 meter/second, and an acoustic flow meter with five transducer acoustic planes.

FIG. 27 shows flow rate measurement error graphs for one system, wherein the system has a 90-degree elbow disturbance element, a flow rate of 2.82942 meter/second, and an acoustic flow meter with two transducer acoustic planes.

FIG. 28 shows flow rate measurement error graphs for one system, wherein the system has a 90-degree elbow disturbance element, a flow rate of 2.82942 meter/second, and an acoustic flow meter with three transducer acoustic planes.

FIG. 29 shows flow rate measurement error graphs for one system, wherein the system has a 90-degree elbow disturbance element, a flow rate of 2.82942 meter/second, and an acoustic flow meter with four transducer acoustic planes.

FIG. 30 shows flow rate measurement error graphs for one system, wherein the system has a 90-degree elbow disturbance element, a flow rate of 2.82942 meter/second, and an acoustic flow meter with five transducer acoustic planes.

FIG. 31 shows flow rate measurement error graphs for one system, wherein the system has a 90-degree elbow disturbance element, a flow rate of 12 meter/second, and an acoustic flow meter with two transducer acoustic planes.

FIG. 32 shows flow rate measurement error graphs for one system, wherein the system has a 90-degree elbow disturbance element, a flow rate of 12 meter/second, and an acoustic flow meter with three transducer acoustic planes.

FIG. 33 shows flow rate measurement error graphs for one system, wherein the system has a 90-degree elbow disturbance element, a flow rate of 12 meter/second, and an acoustic flow meter with four transducer acoustic planes.

FIG. 34 shows flow rate measurement error graphs for one system, wherein the system has a 90-degree elbow disturbance element, a flow rate of 12 meter/second, and an acoustic flow meter with five transducer acoustic planes.

FIGS. 35 to 38 show an embodiment to illustrate effects of measurement path orientations on acoustic flow measurements.

FIG. 35 shows an elbow conduit 800 with a 90-degree bend with a flow profile 802 of a fluid flowing through the conduit 800.

The conduit 800 is applied in a variety of industrial applications. The elbow conduit 800 acts a fluid flow disturbance element, wherein the centrifugal force of the fluid flowing in the conduit 800 acts more to the faster flowing fluid particles in the centre of the conduit 800 than on the slower flowing particles near the wall of the conduit 800.

As seen in FIG. 36, this results in a secondary flow 810 that is directed in the centre to the outside of the elbow conduit 800 and a secondary flow 820 that is directed at a wall to an inner side of the elbow conduit 800. Simultaneously, the maximum velocity 830 of the fluid is shifted to the outside of the elbow conduit 800.

Based on the FIG. 35, it is evident, that the secondary flows 810 and 820 would influence acoustic flow measurements along measurement paths in vertical planes 840, as seen in FIG. 37, rather than along measurement paths in horizontal planes 850, as seen in FIG. 38.

Therefore, the measurements resulted along the paths depends on the corresponding orientations of the paths 840 relative to the disturbance element 800.

Thus, the orientation of the acoustic paths in relation to the orientation of the disturbance element has to be considered for flow rate calculations.

In a general sense, the said relative orientation of the disturbance element can be replaced by a fixed coordination system, wherein two orientation parameter sets are defined, namely an absolute orientation of the disturbance element and an orientation of the acoustic measurement paths.

In the fixed coordination system, using the above embodiment, the disturbance element can be defined as having a 90-degree bend and a flow of a fluid in the disturbance element as coming along the y-axis and is diverted to the x-axis, as shown in FIG. 35. The acoustic paths can be defined as measurements paths are in the vertical xy-plane, as shown in FIG. 37 or as measurement paths are in the horizontal xz-plane, as shown in FIG. 38.

The transducers of the acoustic flow meter can have a direct measurement path or a reflected measurement path.

FIG. 39 shows a clamped acoustic transducer pair with a direct measurement path 910. FIG. 39 depicts two transducers 900, which are clamped to a flow conduit 902 by a transducer casing 904.

The transducer casing 904 holds the transducers 900 at pre-determined positions such that the transducers 900 are arranged longitudinally along the conduit 902 in a non-invasive manner, wherein the transducers 900 are offset with respect to one another along the conduit 902.

The transducers 900 are also angled or directed toward pre-determined orientations, which is dependent on the orientation of a flow disturbance element. The acoustic transducers 900 are configured to exchange acoustic signals directly by a direct measurement path 910.

FIG. 40 shows a clamped acoustic transducer pair with a reflected measurement path 920. FIG. 40 shows the transducers 900 of FIG. 39, wherein the transducers 900 are configure to exchange acoustic signals via simple reflection on the opposite wall of the conduit 902 by a reflected measurement path 920.

FIG. 41 shows flow measurements for the above acoustic transducer pair with different relative orientations and with different positions.

The embodiments can also be described with the following lists of features or elements being organized into items. The respective combinations of features, which are disclosed in the item list, are regarded as independent subject matter, respectively, that can also be combined with other features of the application.
1. An acoustic flow meter for measuring a flow rate of a liquid in a liquid conduit, the acoustic flow meter comprising
   at least one acoustic transmitter and receiver pair, the acoustic transmitter and receiver pair measuring a flow speed value of the liquid in the liquid conduit,
   a holder for fixing the acoustic transmitter and receiver pair to the liquid conduit,
   an interface unit for receiving, by a user input,
      a type data, a position data, and an orientation data of a liquid disturbance element, and
   a computer module comprising
      a memory unit that stores
         the type data, the position data, and the orientation data of the liquid disturbance element,
         a plurality of pre-determined types, and pre-determined orientations of a liquid disturbance element, and
      a processor for computing a flow rate of the liquid according to
         the type data, the position data, and the orientation data of the liquid disturbance element, and
         the flow speed value from the acoustic transmitter and receiver pair, and
      an output device for outputting the flow rate.
2. The flow meter according to item 1, wherein
   the flow meter comprises at least two acoustic transmitter and receiver pairs, each acoustic transmitter and receiver pair measuring a flow speed value of the liquid in the liquid conduit at a different level within the liquid conduit.
3. The flow meter according to item 2 further comprising
   a means for individually activating the acoustic transmitter and receiver pairs at different times such that acoustic signals of the transmitter and receiver pairs does not interfering with each other.
4. The flow meter according to one of the above-mentioned items, wherein
   the output device is configured to display the pre-determined types of a liquid disturbance element for a user selection of a specific type data through the interface unit.
5. The flow meter according to one of the above-mentioned items, wherein
   the memory unit also stores a plurality of corresponding pre-determined positions and corresponding pre-determined orientations of the acoustic transmitter and receiver pair, and
   the processor also computes the flow rate according to a position data and an orientation data of the acoustic transmitter and receiver pair.
6. The flow meter according to item 5, wherein
   the interface unit receives the position data and the orientation data of the acoustic transmitter and receiver pair.
7. The flow meter according to one of the above-mentioned items, wherein
   the memory unit further stores
      a plurality of pre-determined flow rates,
      a plurality of corresponding pre-determined positions of the liquid disturbance element, and
      a plurality of corresponding pre-determined flow speed values of the acoustic transmitter and receiver pair.
8. A method of operating an acoustic flow meter for measuring a liquid flow, the acoustic flow meter is attached to liquid conduit, the method comprising
   providing
      a plurality of pre-determined flow rates,
      a plurality of corresponding pre-determined types, corresponding pre-determined positions, and corresponding pre-determined orientations of the liquid disturbance elements, and
      a plurality of corresponding pre-determined flow speed values of the acoustic transmitter and receiver pair,
   receiving a flow speed value of a liquid from the acoustic transmitter and receiver pair,
   determining a flow rate according to
      the type data, the position data, and the orientation data of the liquid disturbance element, and
      the flow speed value from the acoustic transmitter and receiver pair, and
   outputting the flow rate.
9. The method according to item 8 further comprising
   receiving a type data, a position data, and an orientation data of a liquid disturbance element,
10. The method according to item 9 further comprising
   providing a plurality of corresponding pre-determined positions and corresponding pre-determined orientations of the acoustic transmitter and receiver pair, and
   receiving a position data and an orientation data of an acoustic transmitter and receiver pair.
11. The method according to item 10, wherein
   the flow rate also determined according to
   the position data and the orientation data of the acoustic transmitter and receiver pair.
12. The method according to one of items 8 to 11 further comprising
   simulating a flow profile of the liquid according
      to a flow rate, and
      to the type data, the position data, and the orientation data of the liquid disturbance element, and
   storing the flow profile together with the corresponding flow rate and with the corresponding type data, the corresponding position data, and the corresponding orientation data of the liquid disturbance element.
13. The method according to item 12 further comprising
   simulating a flow speed value of the acoustic transmitter and receiver pair according
      to the flow profile and
      to and the position data and the orientation data of the acoustic transmitter and receiver pair, and
   storing the flow speed value of the acoustic transmitter and receiver pair with the corresponding flow profile and with the corresponding position data and the corresponding orientation data of the acoustic transmitter and receiver pair.
14. The method according to one of items 8 to 11 further comprising
   simulating a first flow rate using an integration method according to a flow speed value of the liquid of the acoustic transmitter and receiver pair, and
   storing the first flow rate with the corresponding flow speed value.
15. The method according to item 14, wherein
   the integration method comprises an “Optimal Weighted Integrated For Circular Sections” (OWICS) method.
16. The method according to item 14 or 15 further comprising
   simulating a second flow rate using a finite element method according to the type data, the position data, and the orientation data of the liquid disturbance element,
   determined a compensation factor for the first flow rate with respect to the second flow rate, and
   storing the compensation factor with the corresponding first flow rate and with the corresponding type data, the corresponding position data, and the corresponding orientation data of the liquid disturbance element.
17. The method according to item 16, wherein
   the finite element method comprises a Computational Fluid Dynamics (CFD) method.
18. The method according to item 16 or 17, wherein
   the determining of the flow rate comprises
      retrieving an interim flow rate according to the flow speed value of the liquid of the acoustic transmitter and receiver pair,
      retrieving a compensation factor according to the immediate flow rate and to type data, the position data, and the orientation data of the liquid disturbance element, and
      determining a final flow rate according the interim flow rate and the compensation factor.

### REFERENCE NUMBERS

20 system
22 user interface
24 information repository
26 fluid flow sensor
28 microcontroller
50 method
52 step of measuring real-time fluid flow
54 step of determining parameters of the installation site
56 step of obtaining an associated correction/calibration operation
58 step of determining the corrected rate of flow
100 conduit series
103 acoustic flow meter
105 cylindrical conduit
107 elbow conduit
109 cylindrical conduit
111 spool piece
114 transducer casing
115a transducer
115b transducer
115c transducer
115d transducer
115e transducer
116 cylindrical body
118 flange
119a opening
119b opening
119c opening
119d opening
119e opening
120a acoustic plane
120b acoustic plane
120c acoustic plane
120d acoustic plane
120e acoustic plane
125a acoustic path
125b acoustic path
125c acoustic path
125d acoustic path
125e acoustic path
130 flow chart
131 step
132 step
134 step
136 step
139 step
150 flow chart
153 step
156 step
159 step
162 step
170 flow chart
173 step
179 step
182 step
185 step
200 pull down menu
300 graphical selection menu
400 direct data entry field
500 graphical selection menu
600 flow chart
602 step
605 step
609 step
612 step
800 conduit
802 flow profile
810 secondary flow
820 secondary flow
830 maximum velocity
840 vertical plane
850 horizontal plane
900 transducer
902 flow conduit
904 transducer casing
910 direct measurement path
920 reflected measurement path
Lc length
Dc internal diameter
Lm length
Dm internal diameter

1. An acoustic flow meter for measuring a flow rate of a liquid in a liquid conduit, the acoustic flow meter comprising
at least one acoustic transmitter and receiver pair, the acoustic transmitter and receiver pair measuring a flow speed value of the liquid in the liquid conduit,
a holder for fixing the acoustic transmitter and receiver pair to the liquid conduit,
an interface unit for receiving, by a user input,
a type data, a position data, and an orientation data of a liquid disturbance element, and
a computer module comprising
a memory unit that stores
the type data, the position data, and the orientation data of the liquid disturbance element,
a plurality of pre-determined types, and pre-determined orientations of a liquid disturbance element, and
a processor for computing a flow rate of the liquid according to
the type data, the position data, and the orientation data of the liquid disturbance element, and
the flow speed value from the acoustic transmitter and receiver pair, and
an output device for outputting the flow rate,
wherein
the memory unit also stores a plurality of corresponding pre-determined positions and corresponding pre-determined orientations of the acoustic transmitter and receiver pair, and
the processor also computes the flow rate according to a position data and an orientation data of the acoustic transmitter and receiver pair
wherein
the interface unit receives the position data and the orientation data of the acoustic transmitter and receiver pair.

2. The flow meter according to claim 1, wherein
the flow meter comprises at least two acoustic transmitter and receiver pairs, each acoustic transmitter and receiver pair measuring a slow speed value of the liquid in the liquid conduit at a different level within the liquid conduit.

3. The flow meter according to claim 2 further comprising
a means for individually activating the acoustic transmitter and receiver pairs at different times such that acoustic signals of the transmitter and receiver pairs does not interfering with each other.

4. The flow meter according to claim 1, wherein
the output device is configured to display the pre-determined types of a liquid disturbance element for a user selection of a specific type data through the interface unit.

5. The flow meter according to claim 1, wherein
the memory unit further stores
a plurality of pre-determined flow rates,
a plurality of corresponding pre-determined positions of the liquid disturbance element, and
a plurality of corresponding pre-determined flow speed values of the acoustic transmitter and receiver pair.

6. A method of operating an acoustic flow meter for measuring a liquid flow, the acoustic flew meter is attached to liquid conduit, the method comprising
providing
a plurality of pre-determined flow rates,
a plurality of corresponding pre-determined types, corresponding pre-determined positions, and corresponding pre-determined orientations of the liquid disturbance elements, and
a plurality of corresponding pre-determined flow speed values of the acoustic transmitter and receiver pair,
receiving a flow speed value of a liquid from the acoustic transmitter and receiver pair,
determining a flow rate according to
the type data, the position data, and the orientation data of the liquid disturbance element, and
the flow speed value from the acoustic transmitter and receiver pair, and
outputting the flow rate.

7. The method according to claim 6 further comprising
receiving a type data, a position data, and an orientation data of a liquid disturbance element.

8. The method according to claim 7 further comprising
providing a plurality of corresponding pre-determined positions and corresponding pre-determined orientations of the acoustic transmitter and receiver pair, and
receiving a position data and an orientation data of an acoustic transmitter and receiver pair.

9. The method according to claim 8, wherein
the flow rate also determined according to
the position data and the orientation data of the acoustic transmitter and receiver pair.

10. The method according to claim 6 further comprising
simulating a flow profile of the liquid according
to a flow rate, and
to the type data, the position data, and the orientation data of the liquid disturbance element, and
storing the flow profile together with the corresponding flow rate and with the corresponding type data, the corresponding position data, and the corresponding orientation data of the liquid disturbance element.

11. The method according to claim 10 further comprising
simulating a flow speed value of the acoustic transmitter and receiver pair according
to the flow profile and
to and the position data and the orientation data of the acoustic transmitter and receiver pair, and
storing the flow speed value of the acoustic transmitter and receiver pair with the corresponding flow profile and with the corresponding position data and the corresponding orientation data of the acoustic transmitter and receiver pair.

12. The method according to claim 6 further comprising
simulating a first flow rate using an integration method according to a flow speed value of the liquid of the acoustic transmitter and receiver pair, and
storing the first flow rate with the corresponding flow speed value.

13. The method according to claim 12, wherein
the integration method comprises an “Optimal Weighted Integrated For Circular Sections” (OWICS) method.

14. The method according to claim 12 further comprising
simulating a second flow rate using a finite element method according to the type data, the position data, and the orientation data of the liquid disturbance element,
determined a compensation factor for the first flow rate with respect to the second flow rate, and
storing the compensation factor with the corresponding first flow rate and with the corresponding type data, the corresponding position data, and the corresponding orientation data of the liquid disturbance element.

15. The method according to claim 14, wherein
the finite element method comprises a Computational Fluid Dynamics (CFD) method.

16. The method according to claim 14, wherein
the determining of the flow rate comprises
retrieving an interim flow rate according to the flow speed value of the liquid of the acoustic transmitter and receiver pair,
retrieving a compensation factor according to the immediate flow rate and to type data, the position data, and the orientation data of the liquid disturbance element, and
determining a final flow rate according the interim flow rate and the compensation factor.
